(19) United States
(12) Patent Application Publication
(10) Pub. No.: US 2026/0292256 A1
(43) Pub. Date: Sep. 24, 2026

(54) BLOCK-BASED CODEC SUPPORTING TRANSFORM COEFFICIENT PREDICTION AND/OR TRANSFORM IMPROVEMENT

(71) Applicant: FRAUNHOFER-GESELLSCHAFT ZUR FÖRDERUNG DER ANGEWANDTEN FORSCHUNG E, V,, Munchen (DE)

(72) Inventors: Michael SCHÄFER, Berlin (DE); Jonathan Pfaff, Berlin (DE); Heiko Schwarz, Berlin (DE); Detlev Marpe, Berlin (DE); Thomas Wiegand, Berlin (DE)

(21) Appl. No.: 19/694,411

(22) Filed: Jun. 1, 2026

Related U.S. Application Data
(63) Continuation of application No. PCT/EP2024/084126, filed on Nov. 29, 2024.

(30) Foreign Application Priority Data
Dec. 1, 2023 (EP) 23213795.0

(51) Int. Cl. H04N 19/61; H04N 19/11; H04N 19/119; H04N 19/124; H04N 19/176; H04N 19/625

(52) U.S. Cl. CPC H04N 19/61; H04N 19/11; H04N 19/119; H04N 19/124; H04N 19/176; H04N 19/625

(57) ABSTRACT

A block-based codec using transform-based residual coding is described wherein a current transform coefficient of a set of transform coefficients is predicted based on a function, attributes of which have values of previously en/decoded samples neighboring the predetermined block, and if the current transform coefficient is not firstly en/decoded among the set of transform coefficients, one or more previously en/decoded transform coefficients among the set of transform coefficients. Further, a block-based codec is described where the set may have merely one transform coefficient, and one where the transform is improved by computing an additive offset mask for the transform using an improvement function, attributes of which have the transform and the predicted sample filling. The described aspects may be combined.

### CROSS-REFERENCE TO RELATED APPLICATIONS

This application is a continuation of copending International Application No. PCT/EP2024/084126, filed Nov. 29, 2024, which is incorporated herein by reference in its entirety, and additionally claims priority from European Application No. 23213795.0, filed Dec. 1, 2023, which is also incorporated herein by reference in its entirety.

### TECHNICAL FIELD

Embodiments of the invention relate to apparatuses for block based encoding or decoding of pictures using transform coding such as video en/decoders en/decoding pictures of video sequences.

### BACKGROUND OF THE INVENTION

As impressive as recent advances in hybrid video coding technology are, they are still trumped by the seemingly endless growth of video data traffic. This imbalance mainly motivates the research on novel approaches for video compression. The focus of these activities has shifted towards learning-based coding tools, because deep-learned neural networks have proven useful across different areas of video processing.

The latest video compression standards HEVC [3], [4] and VVC [1], [2] encode a video sequence as follows. Each frame is divided into variably-sized blocks, and the original signal of each block is approximated by a prediction signal. This prediction is constructed either by motion compensation using previously reconstructed frames or from reconstructed boundary samples within the same frame. The resulting residual is typically transformed using a DCT or DST transform [5], [6]. In VVC, an optional secondary transform (LFNST) may be applied [7], [8]. Then, the transform coefficients are quantized, possibly by using trellis coded quantization (TCQ) during encoding in VVC [9]. At last, the quantization indices are written to the bitstream using binary arithmetic coding [10].

The entropy coding stage is highly optimized with respect to the aforementioned transforms. The use of orthogonal transforms eases the computation of the distortion because the /2 errors in the sample and transform domain are the same. The strong energy compaction of the DCT-II and DST-VII allows to set high frequencies to zero with little impact on the distortion [5]. Further note that the LFNST is designed as a low-complexity secondary transform with regard to the intra-mode-dependent distribution of the DCT-II-transformed residual [7]. Since the distribution of the transform coefficients can be assumed to be Laplacian, the entropy model for coding the coefficients is designed accordingly [10]-[12]. In theory, the Karhunen-Loeve transform (KLT) is the optimal solution in terms of energy compaction among all linear transforms [13]. However, using the KLT requires to determine the covariance matrix for different parts of the video signal and transmit their eigenvectors, which is impractical. For these reasons, transform coding in VVC is considered a powerful tool.

Considering the advances in learned image compression (LIC), the question arises how one could design nonlinear transforms for block-based video coding [14]. LIC networks are usually built as variational autoencoders with a learned entropy model for transmitting the latents [15]-[17]. This allows for a flexible estimation of the latent distribution where the latents are treated as nonlinear transform coefficients. The parameters of the distribution are encoded as side information (hyperprior) by another variational autoencoder [15], [18], [19]. Hence, when the entropy model is fixed, one of the key advantages of these networks is no longer present. Convolutional neural networks may seem appropriate for supporting multiple block shapes. However, problems arise for small shapes like 4×4 and 8×8, because the training requires sufficiently large patches. Finally, designing RDOQ for the latents is not a trivial problem as past investigations have shown [20], [21].

It is the object of the present invention to provide concepts for block-based codecs using transform-based residual coding which are improved in terms of coding efficiency such as compression rate.

### SUMMARY

An embodiment may have a block based decoder for decoding a predetermined block of a picture, configured to predict a predicted sample filling of the predetermined block, decode a transform of a prediction residual for the predetermined block from a data stream, improve the transform by computing an additive offset mask for the transform using an improvement function attributes of which have the transform, and the predicted sample filling, and subject the transform to a reverse transformation, and correct the predicted sample filling using the prediction residual.

Another embodiment may have a method for block based decoding a predetermined block of a picture, wherein the method has predicting a predicted sample filling of the predetermined block, wherein the method has decoding a transform of a prediction residual for the predetermined block from a data stream, wherein the method has improving the transform by computing an additive offset mask for the transform using an improvement function attributes of which have the transform, and the predicted sample filling, and wherein the method has subjecting the transform to a reverse transformation, and wherein the method has correcting the predicted sample filling using the prediction residual.

Another embodiment may have a method for block based encoding a predetermined block of a picture, wherein the method has predicting a predicted sample filling of the predetermined block, wherein the method has encoding a transform of a prediction residual for the predetermined block into a data stream, as part of a R/D optimizer and/or a prediction loop of the block based encoder, wherein the method has improving the transform by computing an additive offset mask for the transform using an improvement function attributes of which have the transform, and the predicted sample filling, and wherein the method has subjecting the transform to a reverse transformation, and wherein the method has correcting the predicted sample filling using the prediction residual.

Another embodiment may have a non-transitory digital storage medium having stored thereon a computer program for performing a method for block based decoding a predetermined block of a picture, wherein the method has predicting a predicted sample filling of the predetermined block, wherein the method has decoding a transform of a prediction residual for the predetermined block from a data stream, wherein the method has improving the transform by computing an additive offset mask for the transform using an improvement function attributes of which have the transform, and the predicted sample filling, and wherein the method has subjecting the transform to a reverse transformation, and wherein the method has correcting the predicted sample filling using the prediction residual, when the computer program is run by a computer.

Another embodiment may have a non-transitory digital storage medium having stored thereon a computer program for performing a method for block based encoding a predetermined block of a picture, wherein the method has predicting a predicted sample filling of the predetermined block, wherein the method has encoding a transform of a prediction residual for the predetermined block into a data stream, as part of a R/D optimizer and/or a prediction loop of the block based encoder, wherein the method has improving the transform by computing an additive offset mask for the transform using an improvement function attributes of which have the transform, and the predicted sample filling, and wherein the method has subjecting the transform to a reverse transformation, and wherein the method has correcting the predicted sample filling using the prediction residual, when the computer program is run by a computer.

Another embodiment may have a data stream having an encoded representation of a predetermined block of a picture, encoded using the above method for block based encoding according to the invention.

In accordance with a first aspect of the present invention, a block-based codec which uses transform-based residual coding is improved in terms of coding efficiency such as compression rate by, when sequentially en/decoding the set of transform coefficients of the transform of the prediction residual, predicting a current transform coefficient of the set of transform coefficients based on a function, attributes of which comprise values of previously coded samples neighboring the predetermined block, and, if the current transform coefficient is not firstly coded among the set of transform coefficients, one or more previously coded transform coefficients among the set of transform coefficients so that merely a transform coefficient residual is coded for the current transform coefficient in the data stream. The function may be embodied as a non-linear function such as a neural network and the inventors of the present application realized that the coefficient prediction realized by this function achieves the coding efficiency improvement in a manner harmonizing with choosing the transform to be non-linear and/or using dependent quantization such as TCQ, or rate-distortion-optimized quantization (RDOQ) for the quantization of the transform coefficients. The current transform coefficient, as predicted and corrected, may then provide a basis for predicting a next transform coefficient of the set of transform coefficients. The transform coefficients may thus be quantized sequentially, e.g. one by one, resulting in an improved tradeoff between implementation effort and a good rate-distortion relation. As the transform coefficient prediction does not rely on using a dedicated entropy model, it permits efficient implementations in existing entropy coding approaches without being subjected to major modifications.

Accordingly, in accordance with the first aspect of the present application, a block based decoder/encoder for decoding/encoding a predetermined block of a picture is configured to predict a predicted sample filling of the predetermined block. The video decoder is configured to decode a transform of a prediction residual for the predetermined block from the data stream by sequentially decoding a set of transform coefficients of the transform of the prediction residual from the data stream by predicting a current transform coefficient of the set of transform coefficients based on a function, attributes of which comprise values of previously decoded samples neighboring the predetermined block, and if the current transform coefficient is not firstly decoded among the set of transform coefficients, one or more previously decoded transform coefficients among the set of transform coefficients, decoding a transform coefficient residual for the current transform coefficient from the data stream, correcting the current transform coefficient using the transform coefficient residual so as to, if the current transform coefficient is not lastly decoded among the set of transform coefficients, serve as a basis of a prediction of a next transform coefficient among the set of transform coefficients, and subject the transform to a reverse transformation, and correct the predicted sample filling using the prediction residual. The video encoder is configured to encode a transform of a prediction residual for the predetermined block into the data stream by sequentially encoding a set of transform coefficients of the transform of the prediction residual into the data stream by predicting a current transform coefficient of the set of transform coefficients based on a function, attributes of which comprise values of previously encoded samples neighboring the predetermined block, and if the current transform coefficient is not firstly encoded among the set of transform coefficients, one or more previously encoded transform coefficients among the set of transform coefficients, encoding a transform coefficient residual for the current transform coefficient into the data stream using which the current transform coefficient is correctable as to, if the current transform coefficient is not lastly encoded among the set of transform coefficients, serve as a basis of a prediction of a next transform coefficient among the set of transform coefficients, and subject the transform to a reverse transformation, and correct the predicted sample filling using the prediction residual. Therefore, the transform coefficients are predicted by use of the function, which, for example, may be a trainable neural network, utilizing statistical dependencies, for example non linear dependencies, among the transform coefficients and the previously decoded/encoded samples neighboring the predetermined block.

In some embodiments of the first aspect of the present application, the function is non-linear with respect to the values of previously decoded/encoded samples, and non-linear with respect to the one or more previously decoded/encoded transform coefficients. For instance, the function may be a trained function or a trained neural network or, as described further below, a set of trained functions or neural networks, one for each of the set of transform coefficients.

In some embodiments of the first aspect of the present application, the function is implemented by, for each transform coefficient of the set of transform coefficients, a neural network, (e.g., associated with the respective TC; selected so that same receives as defined in this paragraph) comprising an initial non-linear fully-connected layer and one or more succeeding layers, the neural network configured to receive the values of the previously decoded/encoded samples, if the respective transform coefficient is not firstly decoded/encoded among the set of transform coefficients, the one or more previously decoded/encoded transform coefficients and one or more further transform coefficients decoded/encoded before the set of transform coefficients as inputs of the initial layer, receive an output of the initial layer as an input of the one or more succeeding layers, and a scalar product computation unit (e.g. associated with the respective TC; selected so that same receives as defined in the next paragraph) configured to compute a scalar product between, if the respective transform coefficient is not firstly decoded/encoded among the set of transform coefficients, the one or more previously decoded/encoded transform coefficients and one or more transform coefficients decoded/encoded before the set of transform coefficients on the one hand and scalar product parameters on the other hand, and a combiner (e.g., addition) configured to combine the scalar product and a scalar output of a final layer among the one or more succeeding layers.

Therefore, the neural network provides an adaptable implementation of the function utilizing the statistical dependencies among previously decoded/encoded samples near the predetermined block and previously decoded/encoded transform coefficients (if present or available) for transform coefficient prediction of the set of transform coefficients. The neural network may be designed, for example trained using sets of training data, without hindering efficient implementations of the entropy coding stage while providing enhanced compression performance such as an improved rate-distortion relation. The implementation effort associated with the neural network may also be configured due to its flexibility such as in terms of network size and network complexity. Further, the neural network may be trained for a variety of block sizes/shapes including small blocks, overcoming deficiencies of conventional approaches which are limited mostly to sufficiently large blocks.

In accordance with a second aspect of the present invention, a block-based codec which uses transform-based residual coding is improved in terms of coding efficiency such as compression rate by, when sequentially en/decoding the set of transform coefficients of the transform of the prediction residual along a scan order, for each of a set of one or more transform coefficients (e.g. a DC transform coefficient, or a zero frequency transform coefficient), predicting the respective transform coefficient based on a function, attributes of which comprise values of previously coded samples neighboring the predetermined block, and one or more previously coded transform coefficients which precede the respective transform coefficient in the scan order so that merely a transform coefficient residual is coded for the respective transform coefficient in the data stream. The function may be embodied as a non-linear function such as a neural network and the inventors of the present application realized that the coefficient prediction realized by this function achieves the coding efficiency improvement in a manner harmonizing with choosing the transform to be non-linear and/or using dependent quantization such as TCQ, or rate-distortion-optimized quantization (RDOQ) for the quantization of the transform coefficients. The respective transform coefficient as predicted is corrected using the transform coefficient residual. The transform coefficients may thus be quantized sequentially, e.g. one by one, resulting in an improved tradeoff between implementation effort and a good rate-distortion relation. As the transform coefficient prediction does not rely on using a dedicated entropy model, it permits efficient implementations in existing entropy coding approaches without being subjected to major modifications.

Accordingly, in accordance with a second aspect of the present application, a block based decoder/encoder for decoding/encoding a predetermined block of a picture is configured to predict a predicted sample filling of the predetermined block. The decoder/encoder is configured to decode/encode a transform of a prediction residual for the predetermined block from/into the data stream by sequentially decoding/encoding transform coefficients of the transform of the prediction residual from/into the data stream along a scan order, for each of a set of one or more transform coefficients, predicting the respective transform coefficient based on a function, attributes of which comprise values of previously decoded/encoded samples neighboring the predetermined block, and one or more previously decoded/encoded transform coefficients, which precede the respective transform coefficient in scan order, decoding/encoding a transform coefficient residual for the respective transform coefficient from/into the data stream, correcting the respective transform coefficient using the transform coefficient residual, and subject the transform to a reverse transformation, and correct the predicted sample filling using the prediction residual. Therefore, the transform coefficients are predicted by use of the function which, for example, may be a trainable neural network, utilizing statistical dependencies, for example non linear dependencies, among the transform coefficients and the previously encoded/decoded samples neighboring the predetermined block.

In some embodiments of the second aspect of the present application, the function is non-linear with respect to the values of previously decoded/encoded samples, and non-linear with respect to the one or more previously decoded/encoded transform coefficients. For instance, the function may be a trained function or a trained neural network or, as described further below, a set of a trained functions or neural networks, one for each of the set of transform coefficients.

In some embodiments of the second aspect of the present application, the function is implemented by for each of the set of one or more transform coefficients, a neural network, comprising an initial non-linear fully-connected layer and one or more succeeding layers, the neural network configured to receive the values of the previously decoded/encoded samples and the one or more previously decoded/encoded transform coefficients, receive an output of the initial layer as an input of the one or more succeeding layers, and a scalar product computation unit configured to compute a scalar product between the one or more previously decoded/encoded transform coefficients on the one hand and one or more scalar product parameters on the other hand, and a combiner configured to combine the scalar product and a scalar output of a final layer among the one or more succeeding layers.

Therefore, the neural network provides an adaptable implementation of the function utilizing the statistical dependencies among previously decoded/encoded samples of the predetermined block and previously decoded/encoded transform coefficients (if present) for transform coefficient prediction of the set of a single transform coefficient such as a DC transform coefficient, or the set of more than one transform coefficients. The neural network may be designed, for example trained using sets of training data, without hindering efficient implementations of the entropy coding stage while providing enhanced compression performance such as an improved rate-distortion relation. The implementation effort associated with the neural network may also be configured due to its flexibility in terms of network size and network complexity. Further, the neural network may be trained for a variety of block sizes/shapes including small blocks, overcoming deficiencies of conventional approaches which are limited mostly to sufficiently large blocks.

In accordance with a third aspect of the present invention, a block-based codec which uses transform-based residual coding is improved in terms of coding efficiency such as compression rate by, when decoding a transform of a prediction residual for the predetermined block, improving the transform by computing an additive offset mask for the transform using an improvement function, attributes of which comprise the transform and the predicted sample filling so that merely a transform coefficient residual is coded for the current transform coefficient in the data stream. The improvement function may be embodied as a non-linear function such as a neural network and the inventors of the present application realized that the coefficient filtering/improvement realized by this improvement function achieves the coding efficiency improvement in a manner harmonizing with choosing the transform to be non-linear and/or using dependent quantization such as TCQ, or rate-distortion-optimized quantization (RDOQ) for the quantization of the transform coefficients. The transform may thus be improved, for example filtered, resulting in an improved tradeoff between implementation effort and a good rate-distortion relation.

Accordingly, in accordance with a third aspect of the present application, a block based decoder/encoder for decoding/encoding a predetermined block of a picture is configured to predict a predicted sample filling of the predetermined block. The decoder is configured to decode a transform of a prediction residual for the predetermined block from a data stream, improve the transform by computing an additive offset mask for the transform using an improvement function, attributes of which comprise the transform, and the predicted sample filling, and subject the transform to a reverse transform, and correct the predicted sample filling using the prediction residual. The encoder is configured to encode a transform of a prediction residual for the predetermined block into a data stream, as part of a R/D optimizer and/or a prediction loop of the block based decoder. The encoder is configured to improve the transform by computing an additive offset mask for the transform using an improvement function, attributes of which comprise the transform, and the predicted sample filling, and subject the transform to a reverse transformation, and correct the predicted sample filling using the prediction residual. Therefore, the transform is improved (for example, filtered) by use of the improvement function, which, for example, may be a trainable neural network, utilizing statistical dependencies, for example non linear dependencies, among the transform and the predicted sample filling.

According to some embodiments of the third aspect of the present application, the improvement function may be implemented by for each of the plurality of intra-prediction modes or for each group of intra-prediction modes into which the plurality of intra-prediction modes is grouped, a neural network, comprising an initial non-linear fully-connected layer and one or more succeeding layers, the neural network configured to receive the transform, the predicted sample filling and the index of the selected intra-prediction mode as inputs of the initial layer, receive an output of the initial layer as an input of the one or more succeeding layers, perform an inference based on the transform and the predicted sample filling, and wherein the block based decoder/encoder is configured to compute the additive offset mask by use of the neural network, which is for the selected intra-prediction mode or for the group which the selected intra-prediction modes is part of.

In some embodiments of the third aspect of the present application, the block based decoder/encoder predicts the predicted sample filling of the predetermined block by selecting a selected intra-prediction mode out of a plurality of intra-prediction modes, and predicting the predicted sample filling using the selected intra-prediction mode, wherein the attributes of the improvement function additionally comprise an index of the selected intra-prediction mode. For instance, the function may be a trained function or a trained neural network for all of the plurality of the intra-prediction modes or a set of a trained functions or neural networks one for each of the plurality of intra-prediction modes

Therefore, the neural network provides an adaptable implementation of the improvement function utilizing the statistical dependencies among the predicted sample filling of the predetermined block and the transform for block-wise transform coefficient filtering. The neural network may be designed, for example trained using sets of training data, without hindering efficient implementations of the entropy coding stage while providing enhanced compression performance such as an improved rate-distortion relation. The implementation effort associated with the neural network may also be adapted due to its flexibility in terms of network size and network complexity. Further, the neural network may be trained for a variety of block sizes/shapes including small blocks, overcoming deficiencies of conventional approaches which are limited to sufficiently large blocks.

Further embodiments according to the invention are defined by the subject matter of the dependent claims of the present application.

### BRIEF DESCRIPTION OF THE FIGURES

Embodiments of the present disclosure are described in more detail below with respect to the figures, in which:

FIG. 1 illustrates an encoder according to embodiments;

FIG. 2 illustrates a decoder according to embodiments;

FIG. 3 illustrates a block partitioning according to embodiments;

FIG. 4 illustrates an implementation of a decoder according to embodiments;

FIG. 5 illustrates an implementation of an encoder according to embodiments;

FIG. 6 illustrates neural networks associated with transform coefficients of a block according to embodiments; and

FIG. 7 illustrates a predicted sample filling of a predetermined block according to embodiments.

### DETAILED DESCRIPTION OF THE INVENTION

In the above sections, specific embodiments have been described. In the following, further embodiments are described which are based on the above thoughts and ideas, but are broadened. Before, however, a general codec framework is described, into which all embodiments for decoder and encoder described herein could be built into, or with which all these embodiments might be combined.

Note that in the drawings the same or similar elements or elements that have the same or similar functionality have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

The description presents in the following two sorts of embodiments, namely some for which experiments have been conducted which are then also presented and some which are derived from the presentation of the former ones. In particular, the former embodiments have been derived by modifying a particular block-based codec using transform-based residual codec and are more specific. The other embodiments form a kind of abstraction or broadening of the more specific embodiments.

The description now starts with a brief description of the more specific embodiments and, in particular, a description of the thoughts which led to these embodiments, wherein these thoughts also motivate the subsequently described, broader embodiments. The new approach described and motivated herein leads to a design of a neural network for nonlinear transform coding in block-based video compression. For instance, the network complements the existing DCTII and DST-VII transforms in VVC and consists of two components. The first component may be characterized as a nonlinear coefficient prediction whereas the other component may filter the reconstructed block of transform coefficients. For example, experiments comprising both components and implemented into the Versatile Video Coding Test Model 14.2 (VTM-14.2) will be described later in the present disclosure.

The main motivation for the design of the nonlinear transforms is the observation that regardless of the intra prediction method and the choice of transforms, the resulting transform coefficients are never entirely decorrelated, and further that even in the case of a KLT whose coefficients are decorrelated by definition, there may be nonlinear dependencies between the coefficients.

Hence, given adequate training data consisting of original blocks, quantized transform blocks and reference samples at the block boundary, a function such as a non-linear function which is, for example implemented by a neural network, can be designed (e.g. trained) to exploit these statistical dependencies. For instance, a conventional approach by the authors of has estimated the probability distributions of the DC and several low-frequency AC coefficients of HEVC intra-predicted residuals using convolutional neural networks. Although the reported bitrate savings of 4.7% against HEVC are impressive, the proposed networks are quite large and require to re-design parts of the entropy coding stage. In particular, the network inference is interleaved with the arithmetic coding, which is a serious problem for efficient implementations. The idea which led to the present embodiments is to design same in a manner so that same fit into the existing, efficient transform coding stage such as that of VVC.

Modern hybrid video codecs like Versatile Video Coding (VVC) heavily rely on transform coding tools. Given a prediction signal at the encoder, the residual is transformed using trigonometric transforms. Rate-distortion-optimized quantization (RDOQ) and entropy coding of the transformed residual is well-understood due to the orthogonality and the energy compaction of these transforms. Within this setting, there is considerable success in optimizing secondary orthogonal transforms. The most prominent example is the Low-Frequency Non-Separable Transform (LFNST) in VVC. However, training nonlinear transforms without re-designing RDOQ and entropy coding stage is a hard problem. In learned image compression, variational auto-encoders have shown impressive results, but they use their own entropy model, remain difficult to train for small blocks and RDOQ is nontrivial for them. Thus, a novel design of a nonlinear transform network for block-based video coding should not suffer from these problems. According to the specific embodiments described hereinbelow, given a transform block, a fully-connected neural network predicts coefficients from previously reconstructed ones and the adherent block boundary, such that only the residual coefficients need to be transmitted. Furthermore, another neural network filters the entire transform block before the inverse transform is applied and the intra prediction signal is added. Against the Versatile Video Coding Test Model 14.2 (VTM-14.2), luma bit-rate savings of approximately 1.8% are reported for the All-Intra configuration. However, due to the structure, the training is feasible without any problem regarding block size and without conflicts which otherwise might restrict transform type and quantization type.

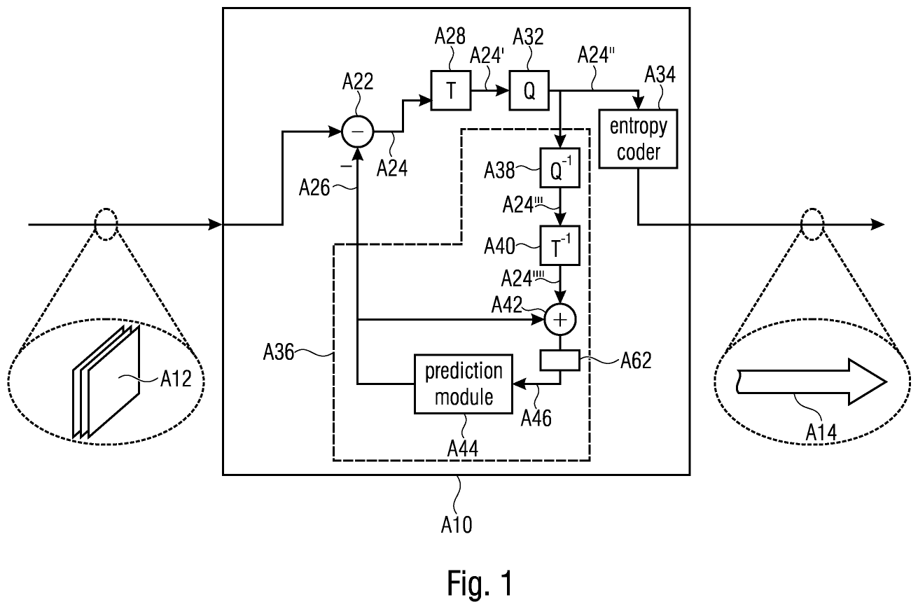

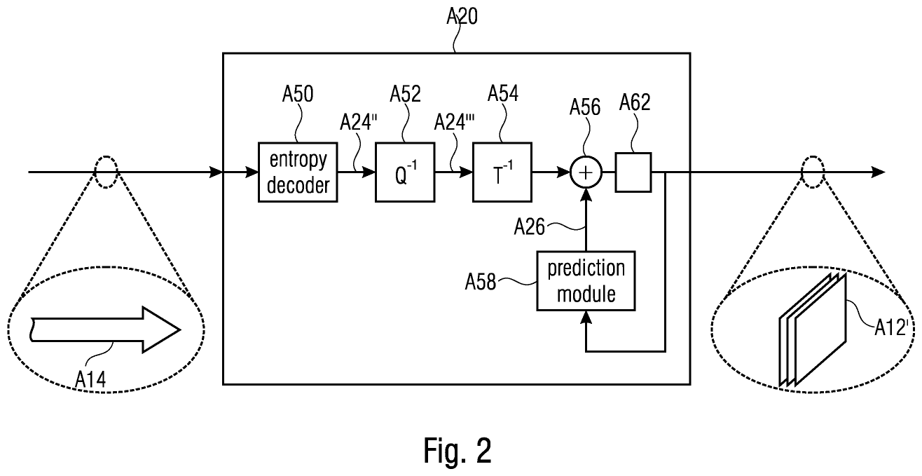

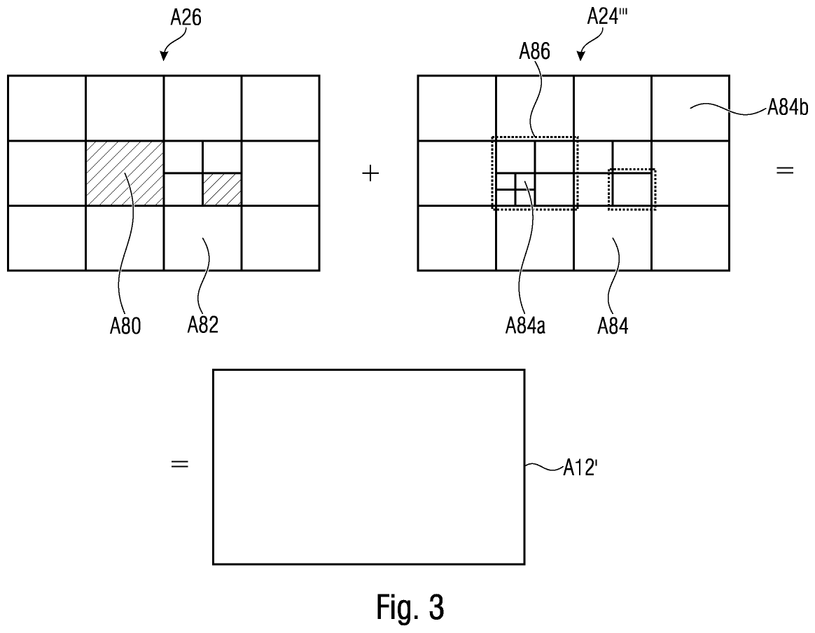

The following description preliminarily switches to a description of the broader or abstracted embodiments. Thereinafter, the description is resumed with the presentation of the more specific embodiments. However, it should be mentioned that any detail(s) described with respect to one embodiment may individually or in combination be used to form a new embodiment when transferred onto a different embodiment. The description starts with a presentation of a description of an encoder and a decoder of a block-based predictive codec for coding pictures of a video in order to form an example for a coding framework into which embodiments of the present invention may be built in. The respective encoder and decoder are described with respect to FIG. 1, FIG. 2, and FIG. 3. Thereinafter the description of the broadened embodiments of the concept of the present invention is presented. While being, as said, combinable with FIGS. 1-3, the embodiments described before and afterwards may, however, also be used to form encoders and decoders not operating according to the coding framework underlying the encoder and decoder of FIG. 1, and FIG. 2.

FIG. 1 shows an apparatus for predictively coding a picture A12 into a data stream A14 exemplarily using transform-based residual coding. The apparatus, or encoder, is indicated using reference sign A10. FIG. 2 shows a corresponding decoder A20, i.e. an apparatus A20 configured to predictively decode the picture 12′ from the data stream A14 also using transform-based residual decoding, wherein the apostrophe has been used to indicate that the picture A12′ as reconstructed by the decoder A20 deviates from picture A12 originally encoded by apparatus A10 in terms of coding loss introduced by a quantization of the prediction residual signal.

The encoder A10 is configured to subject the prediction residual signal to spatial-to-spectral transformation and to encode the prediction residual signal, thus obtained, into the data stream A14. Likewise, the decoder A20 is configured to decode the prediction residual signal from the data stream A14 and subject the prediction residual signal thus obtained to spectral-to-spatial transformation.

Internally, the encoder A10 may comprise a prediction residual signal former A22 which generates a prediction residual A24 so as to measure a deviation of a prediction signal A26 from the original signal, i.e. from the picture A12. The prediction residual signal former A22 may, for instance, be a subtractor which subtracts the prediction signal from the original signal, i.e. from the picture A12. The encoder A10 then further comprises a transformer A28 which subjects the prediction residual signal A24 to a spatial-to-spectral transformation to obtain a spectral-domain prediction residual signal A24′ which is then subject to quantization by a quantizer A32, also comprised by the encoder A10. The thus quantized prediction residual signal A24″ is coded into bitstream A14. To this end, encoder A10 may optionally comprise an entropy coder A34 which entropy codes the prediction residual signal as transformed and quantized into data stream A14. The prediction signal A26 is generated by a prediction stage A36 of encoder A10 on the basis of the prediction residual signal A24″ encoded into, and decodable from, data stream A14. To this end, the prediction stage A36 may internally, as is shown in FIG. 1, comprise a dequantizer A38 which dequantizes prediction residual signal A24″ so as to gain spectral-domain prediction residual signal A24″, which corresponds to signal A24′ except for quantization loss, followed by an inverse transformer A40 which subjects the latter prediction residual signal A24′″ to an inverse transformation, i.e. a spectral-to-spatial transformation, to obtain prediction residual signal A24″, which corresponds to the original prediction residual signal A24 except for quantization loss. A combiner A42 of the prediction stage A36 then recombines, such as by addition, the prediction signal A26 and the prediction residual signal A24″ so as to obtain a reconstructed signal A46, i.e. a reconstruction of the original signal A12. Reconstructed signal A46 may correspond to signal A12′. A prediction module A44 of prediction stage A36 then generates the prediction signal A26 on the basis of signal A46 by using, for instance, spatial prediction, i.e. intra-picture prediction, and/or temporal prediction, i.e. inter-picture prediction.

Likewise, decoder A20, as shown in FIG. 2, may be internally composed of components corresponding to, and interconnected in a manner corresponding to, prediction stage A36. In particular, entropy decoder A50 of decoder A20 may entropy decode the quantized spectral-domain prediction residual signal A24″ from the data stream, whereupon dequantizer A52, inverse transformer A54, combiner A56 and prediction module A58, interconnected and cooperating in the manner described above with respect to the modules of prediction stage A36, recover the reconstructed signal on the basis of prediction residual signal A24″ so that, as shown in FIG. 2, the output of combiner A56 results in the reconstructed signal, namely picture A12′.

Although not specifically described above, it is readily clear that the encoder A10 may set some coding parameters including, for instance, prediction modes, motion parameters and the like, according to some optimization scheme such as, for instance, in a manner optimizing some rate and distortion related criterion, i.e. coding cost. For example, encoder A10 and decoder A20 and the corresponding modules A44, A58, respectively, may support different prediction modes such as intra-coding modes and inter-coding modes. The granularity at which encoder and decoder switch between these prediction mode types may correspond to a subdivision of picture A12 and A12′, respectively, into coding segments or coding blocks. In units of these coding segments, for instance, the picture may be subdivided into blocks being intra-coded and blocks being inter-coded. Intra-coded blocks are predicted on the basis of a spatial, already coded/decoded neighborhood of the respective block as is outlined in more detail below. Several intra-coding modes may exist and be selected for a respective intra-coded segment including directional or angular intra-coding modes according to which the respective segment is filled by extrapolating the sample values of the neighborhood along a certain direction which is specific for the respective directional intra-coding mode, into the respective intra-coded segment. The intra-coding modes may, for instance, also comprise one or more further modes such as a DC coding mode, according to which the prediction for the respective intra-coded block assigns a DC value to all samples within the respective intra-coded segment, and/or a planar intra-coding mode according to which the prediction of the respective block is approximated or determined to be a spatial distribution of sample values described by a two-dimensional linear function over the sample positions of the respective intra-coded block with driving tilt and offset of the plane defined by the two-dimensional linear function on the basis of the neighboring samples. Compared thereto, inter-coded blocks may be predicted, for instance, temporally. For inter-coded blocks, motion vectors may be signaled within the data stream, the motion vectors indicating the spatial displacement of the portion of a previously coded picture of the video to which picture A12 belongs, at which the previously coded/decoded picture is sampled in order to obtain the prediction signal for the respective inter-coded block. This means, in addition to the residual signal coding comprised by data stream A14, such as the entropy-coded transform coefficient levels representing the quantized spectral-domain prediction residual signal A24″, data stream A14 may have encoded thereinto coding mode parameters for assigning the coding modes to the various blocks, prediction parameters for some of the blocks, such as motion parameters for inter-coded segments, and optional further parameters such as parameters for controlling and signaling the subdivision of picture A12 and A12′, respectively, into the segments. The decoder A20 uses these parameters to subdivide the picture in the same manner as the encoder did, to assign the same prediction modes to the segments, and to perform the same prediction to result in the same prediction signal.

FIG. 3 illustrates the relationship between the reconstructed signal, i.e. the reconstructed picture A12′, on the one hand, and the combination of the prediction residual signal A24″ as signaled in the data stream A14, and the prediction signal A26, on the other hand. As already denoted above, the combination may be an addition. The prediction signal A26 is illustrated in FIG. 3 as a subdivision of the picture area into intra-coded blocks which are illustratively indicated using hatching, and inter-coded blocks which are illustratively indicated not-hatched. The subdivision may be any subdivision, such as a regular subdivision of the picture area into rows and columns of square blocks or non-square blocks, or a multi-tree subdivision of picture A12 from a tree root block into a plurality of leaf blocks of varying size, such as a quadtree subdivision or the like, wherein a mixture thereof is illustrated in FIG. 3 in which the picture area is first subdivided into rows and columns of tree root blocks which are then further subdivided in accordance with a recursive multi-tree subdivisioning into one or more leaf blocks.

Again, data stream A14 may have an intra-coding mode coded thereinto for intra-coded blocks A80, which assigns one of several supported intra-coding modes to the respective intra-coded block A80. For inter-coded blocks A82, the data stream A14 may have one or more motion parameters coded thereinto. Generally speaking, inter-coded blocks A82 are not restricted to being temporally coded. Alternatively, inter-coded blocks A82 may be any block predicted from previously coded portions beyond the current picture A12 itself, such as previously coded pictures of a video to which picture A12 belongs, or picture of another view or an hierarchically lower layer in the case of encoder and decoder being scalable encoders and decoders, respectively.

The prediction residual signal A24″ in FIG. 3 is also illustrated as a subdivision of the picture area into blocks A84. These blocks might be called transform blocks in order to distinguish same from the coding blocks A80 and A82. In effect, FIG. 3 illustrates that encoder A10 and decoder A20 may use two different subdivisions of picture A12 and picture A12′, respectively, into blocks, namely one subdivisioning into coding blocks A80 and A82, respectively, and another subdivision into transform blocks A84. Both subdivisions might be the same, i.e. each coding block A80 and A82, may concurrently form a transform block A84, but FIG. 3 illustrates the case where, for instance, a subdivision into transform blocks A84 forms an extension of the subdivision into coding blocks A80, A82 so that any border between two blocks of blocks A80 and A82 overlays a border between two blocks A84, or alternatively speaking each block A80, A82 either coincides with one of the transform blocks A84 or coincides with a cluster of transform blocks A84. However, the subdivisions may also be determined or selected independent from each other so that transform blocks A84 could alternatively cross block borders between blocks A80, A82. As far as the subdivision into transform blocks A84 is concerned, similar statements are thus true as those brought forward with respect to the subdivision into blocks A80, A82, i.e. the blocks A84 may be the result of a regular subdivision of picture area into blocks (with or without arrangement into rows and columns), the result of a recursive multi-tree subdivisioning of the picture area, or a combination thereof or any other sort of blockation. Just as an aside, it is noted that blocks A80, A82 and A84 are not restricted to being of quadratic, rectangular or any other shape.

FIG. 3 further illustrates that the combination of the prediction signal A26 and the prediction residual signal A24″ directly results in the reconstructed signal A12′. However, it should be noted that more than one prediction signal A26 may be combined with the prediction residual signal A24″ to result into picture A12′ in accordance with alternative embodiments.

In FIG. 3, the transform blocks A84 shall have the following significance. Transformer A28 and inverse transformer A54 perform their transformations in units of these transform blocks A84. For instance, many codecs use some sort of DST or DCT for all transform blocks A84. Some codecs allow for skipping the transformation so that, for some of the transform blocks A84, the prediction residual signal is coded in the spatial domain directly. However, in accordance with embodiments described below, encoder A10 and decoder A20 are configured in such a manner that they support several transforms. For example, the transforms supported by encoder A10 and decoder A20 could comprise:
DCT-II (or DCT-III), where DCT stands for Discrete Cosine Transform
DST-IV, where DST stands for Discrete Sine Transform
DCT-IV
DST-VII
Identity Transformation (IT)

Naturally, while transformer A28 would support all of the forward transform versions of these transforms, the decoder A20 or inverse transformer A54 would support the corresponding backward or inverse versions thereof:
Inverse DCT-II (or inverse DCT-III)
Inverse DST-IV
Inverse DCT-IV
Inverse DST-VII
Identity Transformation (IT)

The subsequent description provides more details on which transforms could be supported by encoder A10 and decoder A20. In any case, it should be noted that the set of supported transforms may comprise merely one transform such as one spectral-to-spatial or spatial-to-spectral transform.

As already outlined above, FIG. 1, FIG. 2 and FIG. 3 have been presented as an example where the inventive concept described further below may be implemented in order to form specific examples for encoders and decoders according to the present application. Insofar, the encoder and decoder of FIG. 1, and FIG. 2, respectively, may represent possible implementations of the encoders and decoders described herein below. FIG. 1, and FIG. 2 are, however, only examples. An encoder according to embodiments of the present application may, however, perform encoding of a picture 12 using the concept outlined in more detail below and being different from the encoder of FIG. 1 such as, for instance, in that same is no video encoder, but a still picture encoder, in that same does not support inter-prediction, or in that the sub-division into blocks A80 is performed in a manner different than exemplified in FIG. 3. Likewise, decoders according to embodiments of the present application may perform block-based decoding of picture A12′ from data stream A14 using the coding concept further outlined below, but may differ, for instance, from the decoder A20 of FIG. 2 in that same is no video decoder, but a still picture decoder, in that same does not support intra-prediction, or in that same sub-divides picture A12′ into blocks in a manner different than described with respect to FIG. 3, for instance.

As illustrated in FIG. 2, decoder A20 may further comprise a filtering module A62, which filters the reconstructed signal A12′, the prediction A58 being performed based on the filtered reconstructed signal A12′. Similarly, encoder A10 of FIG. 1 may comprise a filtering module A62, which may perform the same filtering as filtering module A62 of decoder A20, in the prediction stage A36 to filter the reconstructed signal A46. As the filtering is performed in the prediction loop provided by prediction stage A36 (e.g., in combination with operator A22, transformer A28, and quantizer A32), the filtering by filtering module A62 and/or filtering module A62′ may be referred to as in-loop filtering. Accordingly, embodiments of the invention may optionally be implemented as described with respect to FIGS. 1, 2, and 3.

In the following, embodiments of the invention are described, which may optionally be implemented as described with respect to FIG. 1, FIG. 2, and/or FIG. 3, wherein the features described above may be combined with the embodiments described below individually or in combination with each other. For instance, in-loop filtering A62 might be missing. Further, inter-prediction might not be used, or, vice versa, intra-prediction.

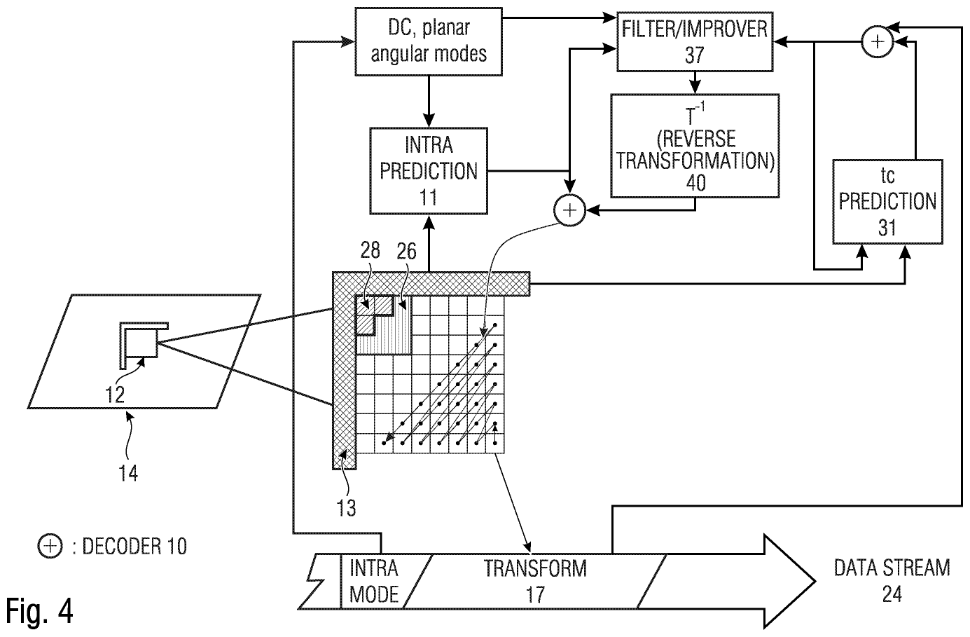

FIG. 4 shows an embodiment of a block based decoder 10. As said, the decoder may be a video decoder or a picture decoder which, in addition to the details set out with respect to FIG. 4, comprises one or more of the functionalities described above with respect to FIGS. 1 to 3.

Especially, the decoder 10 of. FIG. 4 supports, for instance, a certain coding mode or coding tool which is illustrated in FIG. 4 for a predetermined block 12 of a picture 14. In line with what has been already been stated earlier, this picture 14 may either be a part of a video sequence or be a part, or possibly a whole, of an image such as a standalone still image. While block 12 might be an inter-predicted block or an intra-predicted block, FIG. 4 illustrates the case where the block 12 is an intra-predicted block.

As already mentioned, the decoder 10 performs the decoding in a block-wise or block-based manner. That is, the decoder 10 subdivides the picture 14 into one or more blocks, in units of which the decoder 10 decodes the picture 14 from the data stream 24. Generally, the subdivision may end up into one or more blocks of constant size such as an array of blocks arranged in rows and columns or into one or more blocks of different block sizes such as derived by use of a hierarchical multi-tree subdivisioning applied to the whole picture area of picture 20, or derived from a pre-partitioning of picture 14 into an array of tree blocks which are then subject to multi-tree subdivisioning. The hierarchical subdivision information may be signalled in the datastream. It is noted that these examples shall not be considered as excluding other possible approaches of subdivisioning the picture 14 into one or more blocks. Thus, the predetermined block 12 which the decoder 10 decodes may be formed from the picture 14 using such or similar approaches.

Note that the predetermined block 12 may by a quadratic block or a rectangular or non-square block, while any other shape may be used as well.

The decoder 10 predicts 11 a predicted sample filling 18 of the predetermined block 12 using an intra-prediction mode which the decoder 10 derives from the data stream 24, such as decoding an index of the intra-prediction mode from the data stream 24.

In particular, the predicted sample filling 18 of the predetermined block 12 might be predicted by selecting an intra-prediction mode out of a plurality of intra-prediction modes which the decoder 10 supports. Examples of the plurality of intra-prediction modes supported by the decoder 10 include, in accordance with embodiments, one or more of a DC mode, a planar mode, a plurality of angular modes, one or more matrix-based intra prediction (MIP) modes, according to each of which the predicted sample filling 18 is obtained by a multiplication between a matrix associated with the respective matrix-based intra prediction mode and a vector obtained from sample values in a neighborhood of the predetermined block, and one or more intra-subpartition modes, according to each of which the predicted sample filling is obtained by subdividing the predetermined block into subpartitions and intra-predicting the subpartitions sequentially with correcting a subpartition using the prediction residual before intra-predicting a next subpartition. Any combination of the just-mentioned modes shall form the supported set of intra-prediction modes of the decoder 10.

Note that, in any of the just-described intra-prediction modes, the previously decoded samples base on which the block inner is predicted need not to be directly adjacent to block 12. Rather, the neighborhood 13 within which the decoded samples are located based on which the block inner is predicted may also cover or merely cover previously decoded samples which are not directly adjacent to the block boundary. The previously decoded samples based on which the intra-prediction is performed may be located using a certain criterion such as, for example, one locating same in terms of a specific maximum distance from the block boundary or the like. That is, for instance, the neighborhood may denote a template of previously decoded samples each having a distance from the block boundary of block 12 which is equal to or smaller than a specific distance and this specific distance may be defined by default or may be transmitted in the data stream.

The one or more intra-subpartition modes may subdivide the predetermined block 12 into subpartitions along a first direction (e.g. a horizontal direction) and/or along a second direction (e.g. a vertical direction). In case of subdividing only along one direction, the subpartitions might be as wide as the block 12 in a direction perpendicular to the direction of subdividing the block 12 into the partitions. The sub-partitions might then be intra-predicted and corrected using the block's prediction residual sequentially, thereby improving the intra predictor for subsequently intra predicted sub-partitions.

Again, the examples provided in FIG. 4 are merely an example. Decoder 10 might support further intra-prediction modes or fewer or a different collection. Further, it is feasible that the decoder 10 may select more than one intra-prediction mode for predicting the predicted sample filling 18 so as to perform the prediction using multiple hypotheses. For the selection of the intra prediction mode, the decoder 10 may decode an index from the data stream 24 for block 12 which index is indicative of the selected intra prediction mode.

The predicted sample filling 18 is generated using the selected intra-prediction mode based on the values of already decoded samples in the neighborhood 13 of the predetermined block 12. As described, these samples in area 13 may directly abut the circumference, or boundary, of block 12, but area 13 may additionally or alternatively comprise other samples. As shown in FIG. 4, the already decoded samples in the area 13 may be adjacent, or located next, to the predetermined block 12 along a left-hand boundary of the predetermined block 12 and a top boundary of the predetermined block 12.

Again, FIG. 4 illustrates concepts of decoder 10 with respect to an intra-predicted block, although these concepts would be readily transferable onto inter-predicted blocks, so as to be configured to apply these concepts onto such inter-predicted block alternatively or additionally. Further, the decoder 10 may use intra-prediction in combination with inter-prediction to predict the predicted sample filling 18. For example, although not depicted in FIG. 4, the decoder 10 may be configured to combine a predictor resulting from intra-prediction with one obtained by inter-prediction. For inter-prediction, the decoder 10 may be configured to decode information on motion vector(s) for block 12 from the data stream so as to perform motion-compensated prediction of block 12.

The decoder 10 further decodes a transform 17 of a prediction residual for the predetermined block 12 from the data stream 24 based on which the predicted filling 18 is finally corrected. The decoder 10 derives the transform 17 by sequentially decoding its transform coefficients from the data stream 24 along a scan order 15 which, for instance, leads from a transform coefficient having, expectationally, lowest energy such as the highest frequency transform coefficient in case of a spectrally decomposing transform towards the transform coefficient having, expectationally, highest energy such as the lowest frequency transform coefficient (e.g. a zero frequency TC) in case of a spectrally decomposing transform. It should be noted that decoder 10 might support more than one transformation or transform domain for coding the prediction residual of blocks of picture 14 such as block 12, or may only support one such transformation or transform domain, and that the supported transformation(s) is/are not restricted to DCT or DST or derivatives therefrom or to some other orthogonal transformation, but may include non-orthogonal transformation(s) additionally or alternatively. That is, decoder 10 may support more than one transformation type. For example, the decoder 10 may select the transformation to be used for block 12 based on information derived from the data stream 24. This transformation selection may be implicit, i.e. be performed based on one or more certain characteristics of block 12, or explicit, i.e be done based on an explicit signal selecting the transformation to be used out of a set of transformations usable for block 12. That is, as an optional example, the selected transformation may be selected on the basis of information associated with any of the predetermined block 12 such as based on an analysis of the predicted sample filling 18, based on the selected intra-prediction mode or based on the selected inter-prediction mode.

For example, the transform 17 may be 1) a DCT-II or DST-VII, 2) in accordance with transforms of existing coding frameworks such as VVC, or 3) as another exemplary possibility a combination of DCT-II and DST-VII such as using one transform in x and the other in y direction. It should also be noted that in examples the transform 17 may possibly even be selected out of a set of transforms including an identity transformation. In case of such identity transform being selected for block 12, the (re) transformation would be skipped for coding block 12 and transform 17 would, in fact, be the residual signal of block 12 in spatial domain directly. Further, the transformation may be a concatenation of more than one transformation.

Moreover, the size of the transform 17 may be such that it corresponds to the size of block 12 in terms of samples, but this may also be different, i.e. the number of coefficients may equal the number of samples in block 12. Alternatively, the size of the transform 17 may be such that it corresponds to that of a sub-block of the block 12. The scan order 15 might lead, for instance, diagonally from highest frequency transform coefficient to DC coefficient.

There are different transform coefficients of the transform 17 in the example of FIG. 4, wherein the coefficients are drawn in FIG. 4 by small squares, or differently, the decoder 10 behaves differently with respect to different ones of these transform coefficients: for set 28 of transform coefficients which may include the one at the end of scan order 15, for instance, the decoder 10 performs a TC prediction 31 discussed in more detail below, with decoding from the data stream 24 only a TC residual for the respective TC, while decoding the TC completely or unpredicted from the data stream, or without TC prediction 31, with respect to other TCs not in set 28. In predicting TCs in set 28, some TCs, here denoted as 26, serve as a prediction basis, while there may be, optionally, and maybe depending on the size of block 12 and transform 17, respectively, TCs 27 which do not serve as a prediction basis for TC prediction 31 and which are also not predicted. In other words, the TCs 26 provide support for prediction 31 of the TCs in the set 28. Note that, the fact whether there are any TCs 27 which do not provide support for the prediction 31 and are themselves not subject to the prediction 31, may depend on the size of the block 12 and/or the transform 17 selected for block 12. Thus, the decoder 10 decodes the transform 17 from the data stream 24 by use of the scan order 15 wherein the set of transform coefficients 28 are, in the example of FIG. 4, scanned latest among all transform coefficients. Here all transform coefficients are understood to be a collection of the set of transform coefficients 28, the further transform coefficients 26 and, if present, the even further transform coefficients 27. In simpler words, the even further transform coefficients 27 comprise transform coefficients which neither belong to the set of transform coefficients 28 nor the further transform coefficients 26.

In the example of FIG. 4, the scan order 15 traverses each TC 26 prior to set 28, while some TCs 26 are traversed in a manner interleaved with the TCs 27. Again, this is merely an example and alternatives are possible. Alternative scan orders may include scan orders in which the predicted TCs 28 are traversed interleaved with TCs 26 and, if present, TCs 27. Understandably, further variations of the just-outlined scan orders exist.

As to the scan order 15 it should be noted that same may be one of a horizontal raster scan order, a vertical raster scan order, a diagonal scan order or a zigzag scan order or an order defined by an evaluation of statistics gained from previously decoded blocks. The scan order 15 finally used for block 15 may be derived by the decoder based on implicit or explicit signaling in the data stream.

It is noted that in accordance with embodiments of the present disclosure, the set of transform coefficients 28 comprise a DC transform coefficient of the transform 17 such as in case of the transformation being a DST or DCT.

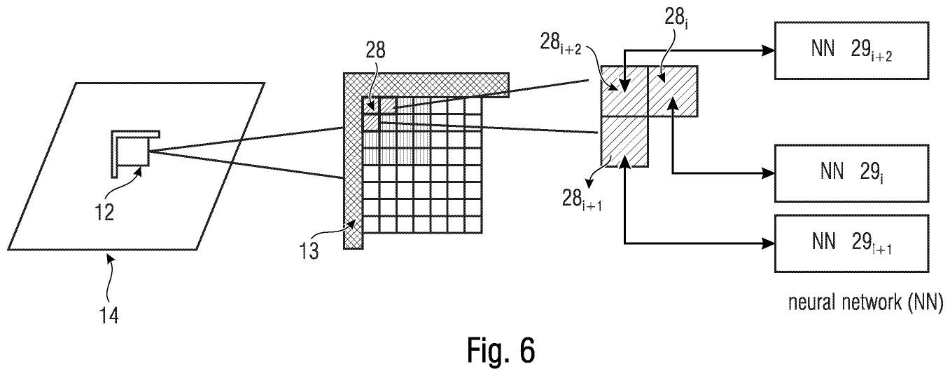

With respect to the set 28 of predicted TCs, the decoder 10 operates as follows: each transform coefficient of set 28 of the set of transform coefficients is predicted using a function, which is implemented by a corresponding or associated neural network: That is, as shown in FIG. 6, decoder 10 manages or comprises a neural network 29ᵢ for each TC 28ᵢ of set 28. Although FIG. 6 depicts neural networks, NN, 29ᵢ, 29ᵢ₊₁, 29ᵢ₊₂, each corresponding to a corresponding TC within set 28, alternatives exist. For instance, a single neural network may support the prediction 31 for all TCs in the set 28, wherein the TC's index currently being predicted being a further input. It is even feasible that multiple neural networks might support the prediction 31 of a single TC of the set of TCs 28. Further, for instance, it can be the case that among multiple neural networks, some NNs might simply be copies of each other (e.g. identical to each other) or that one neural network is re-used for more than one corresponding TC within set 28, the difference only residing in the inputs applied to the NN, for example, such as the respective x preceding TCs in scan order.

The attributes of the function or, in different terms, the input of network 29i, comprises
1) the values of the previously decoded samples neighboring the predetermined block in area 13; note that the value of the samples might be the reconstructed sample value as obtained by prediction and correction using a prediction residual, or might be simply the predicted value of these samples as obtained, for instance, by intra- or inter-prediction. For example, it may also be that some of the previously decoded samples might be reconstructed sample values while some other of the previously decoded samples might be predicted values.

Further, 2) if the transform coefficient 28ᵢ is not firstly decoded among the set 28, one or more previously decoded transform coefficients among the set 28 of transform coefficients is used as an attribute of the function or as input for the network 29ᵢ. The number of such TCs 28_{j<i} out of set 28 on the basis of which a TC 28ᵢ of set 28 is predicted might depend on i in that, for instance, all previous TCs 28_{j<i} in set 28 are used, but there are alternatives imaginable according to which, for instance, the number is limited so as to not exceed some maximum number or the like. For instance, as an optional exemplary scenario, in which the prediction 31 of TCs may be conditioned to using only two previously decoded TCs from the set 28 (as per a predetermined criterion or the like thereof), then it follows that for the prediction 31 of the TC 28ᵢ₊₃ any two previously decoded TCs 28ᵢ and 28ᵢ₊₁, or 28ᵢ₊₁ and 28ᵢ₊₂ or 28ᵢ and 28ᵢ₊₂ may be used but not all the three already decoded TCs 28ᵢ, 28ᵢ₊₁, 28ᵢ₊₂ together. Again, other examples or alternatives are possible.

It should be noted that the indices of the TCs 28ᵢ follow the scan order 15 (i.e. the reverse diagonal scan order 15 running from the highest frequency TC to the lowest frequency TC in a diagonal manner), that is, the indices run in a manner such that the TC preceding another in index order corresponds to a relatively higher frequency TC. For instance, as shown in FIG. 4, the set 28 of TCs comprises a TC 28₂ as possibly the DC coefficient (in the top left corner), a TC 28₁ which is vertically below the TC 28₂ and has a higher frequency than that of the TC 28₂, and the TC 28₁ which is horizontally right of the TC 28₀ and diagonally right of the TC 28₁ and has a higher frequency than that of the TC 28₁.

Further, 3) TCs 26 are used as an attribute of the function or as input for the network 29ᵢ. Again, while all such TCs 26 might be used for predicting each TC 28ᵢ of set 28, there are alternatives imaginable according to which, for instance, the number depends on i such by using these TCs 26 only to ones having distance to predicted TC 28ᵢ which is below a certain maximum distance.

Thus, in decoding the transform 17, the decoder 10 sequentially decodes the TCs and, if ever the currently decoded TC is one of set 28, it performs the TC prediction 31 with correcting 33 the TC predictor 32 using a TC prediction residual value decoded for that TC from the data stream 24. In performing the TC prediction 31, the decoder 10 chooses the corresponding NN 29ᵢ corresponding to the currently decoded TC 28ᵢ, and feeds it with the required inputs listed and discussed in the previous paragraph so that the NN 29ᵢ outputs the TC predictor 32 or contributes to the TC predictor 32. In addition to NN 29ᵢ, each TC 28ᵢ might have a set of scalar product parameters 35ᵢ associated therewith, i.e. weights forming a scalar product along with the TCs under items 2) and 3) above, of which parameters are chosen according to i as well while the resulting product is added to the NN output to yield the TC predictor 32. However, even this may be varied. For instance, a NN may be used alone to yield the TC predictor 32 for each coefficient in set 28, or even a different non-linear function may be used to this end. Even further, while only a NN might be used for some TC of set 28, a combination with a scalar product might be used for the others.

As another optional feature, the NN 29 in the above description comprises a non-linear activation function, as an example a rectified linear unit (ReLu). It is to be noted that other forms which introduce any non-linearities may be used in combination with or without the ReLu.

For instance, it holds in general, according to embodiments, the activation functions in the layers of the NN 29 may include non-linear functions such as leaky ReLu, tanh, binary step function, SELU, ELU, sigmoid/logistic and/or parametric ReLu. This means, for example, that a first grouping of the layers of the NN 29 may comprise non-linear activation functions different from a second grouping of the layers of the NN 29. As another optional feature, it also holds in general, that any of the layers of the NN 29 may comprise more than one non-linear activation function. Additionally or alternatively, as an instantiation, some of the layers, or some neurons among the layer, of the NN 29 may even comprise an identity function as the activation function.

Thus, decoder 10 performs the prediction 31 of a current TC of the set of TCs 28 based on a function. In embodiments, the attributes of the function comprise 1) values of already decoded samples in a neighborhood 13 of the predetermined block 12 and 2) already predicted TCs from the set of TCs 28 provided the current TC is not the first TC to be decoded. This means that the function may depend on the already decoded samples 13 and the already predicted TCs (among the set 28). As an example, if the current TC is the first to be decoded, the function may depend, possibly only on, the already decoded samples in neighborhood 13. In accordance with embodiments of the present disclosure, the function may be non-linear with respect to both the already decoded samples 13 and the already predicted TCs (among the set 28). This means, for example, that the function may be implemented using concepts which exploit a non-linear dependence on the already decoded samples in neighborhood 13 and the already decoded (with respect to prediction 31 corrected) TCs (among the set 28). An example of such concepts is provided in the form of neural networks further in the disclosure, which may optionally be trainable using training data.

The function may be non-separable with respect to both the already decoded samples and the already predicted TCs. This means, for example, that the function does not permit a decomposition into one or more parts associated with the already decoded samples 13 and one or more parts associated with the already predicted TCs (among the set 28). That is, the function may still comprise parts associated with the samples 13 as well as the already decoded TCs after decomposition. In other words, for example, the function may not be expressed in a form which allows a distinction, or a separation, between pieces depending on the already decoded samples and pieces depending on the already predicted TCs.

According to embodiments, the attributes of the function may additionally comprise further TCs 26 decoded before the set of TCs 28 wherein the further TCs 26 precede the set of TCs 28 in the scan order. That is, the further TCs 26 may be decoded before the predicted TCs 28. Even more precisely, for instance, each of the further transform coefficients 26 may be decoded before each of the predicted TCs 28, and even the scan order 15 may be adapted with respect to this precedence.

Possibly, the function might be non-separable with respect to the further TCs 26 in addition to the already described attributes. Further, the function might also be non-linear with respect to the further TCs 26.

According to embodiments, it may be that a number and positions of the further TCs 26 comprised by the attributes of the function additionally are equal to each other for different ones of the set of TCs 28. In other words, for different TCs (i.e. predicted TCs) of the set 28, corresponding sets of further TCs 26, on which the function may rely upon, may coincide with each other in terms of number and positions. It might alternatively be that the corresponding sets of further TCs 26 for each of the different TCs belonging to the set 28 may be equal to each other for either the number or the positions of the further TCs 26 comprised by the attributes of the function.

Further, according to embodiments, the one or more previously decoded TCs among the set of TCs 28 may comprise all previously decoded TCs among the set of TCs 28, if any, for each of the TCs 28.

As will be described in further detail below, the function underlying prediction 31 may be obtained using a learning-based. That is, the function may be a trained a neural network, trained using training data. In accordance with embodiments, the neural network 29 may comprise an initial non-linear fully-connected layer and one or more succeeding layers. The non-linear quality of the initial layer of the neural network 29 may be due to its non-linear dependency on inputs of the NN 29 to which it is connected, whereas the fully-connected quality of the initial layer may relate to every input of the initial layer being connected to every input of a layer (or, for instance, layers) immediately succeeding the initial layer such as any among the one or more succeeding layers. By this measure, the initial layer of the NN 29 provides, for instance, a complete linkage between the initial layer and the one or more succeeding layers. The neural network 29 may receive the values of the previously decoded samples and if the respective TC is not firstly decoded among the set 28, the one or more previously decoded TCs and one or more further TCs 26 decoded before the set 28 as inputs of the initial layer, and may receive an output of the initial layer as an input of the one or more succeeding layers. The implementations of the function, for each TC among the set 28, may further comprise a scalar product computation unit computing a scalar product between, if the respective TC is not firstly decoded among the set 28, the one or more previously decoded TCs and one or more transform coefficients decoded before the set 28 on the one hand and scalar product parameters 35 on the other hand. The implementations of the function may further comprise a combiner (e.g. addition) combining the scalar product and a scalar output of a final layer among the one or succeeding layers. For example, the combiner of the NN 29 may simply add, or for instance average, the scalar product and the scalar output. In examples, the combiner may even combine the scalar product and the scalar output as per a weighted averaging operation.

In embodiments of the present disclosure, the final layer of the one or more succeeding layers of the neural network 29 might be a linear layer. For instance, it is to be understood that linearity of the final layer is with respect to the attributes, or inputs, of the neural network 29 implementing the function. As a particular example, the final layer may simply be linear in terms of the inputs provided to it by a penultimate layer (i.e. a layer immediately preceding the final layer), or in other examples, by further layers even preceding the penultimate layer.

As said, the decoder 10 decodes, for each TC of set 28, a transform coefficient residual from the data stream 24 and uses same for correcting the TC predictor 32 having been derived for same as described above. Entropy decoding might be used to this end. In particular, it might be that the decoder 10 applies the TC prediction 31 of TCs in set 28 not to all blocks having the same size as block 12, and may use context adaptive entropy decoding for decoding the TCs and in this case, it might be that, while a certain transform coefficient 28ᵢ at a certain rank position i along scan order 15 uses one or more first contexts, while for a TC at the same position i of a different block of the same size (and shape) no TC prediction 31 is applied and this TC at this position is decoded using these same contexts, i.e. the contexts' probabilities adapt to statics to which both TCs at this position i contribute. It might be that the prediction mode decides whether the block 12 uses TC prediction 31 or not, for instance.

Thus, according to embodiments of the present disclosure, describing in more generality what has been described in the previous paragraph, the decoder 10 may be configured to predict a certain transform coefficient of within the set of transform coefficients 28 based on the function, in case of a prediction mode of the predetermined block 12 fulfilling a predetermined criterion, and not use the TC prediction 31 for the set of transform coefficients 28 at all (or set a predicted value for each TC within this set to zero), in case of a prediction mode of the predetermined block 12 not fulfilling the predetermined criterion. However, according to the just-mentioned embodiment, the same context(s) would be used for en/decoding each transform coefficient within set 28, i.e. for the prediction residual in case of using TC prediction 31, and for the TC in case of not using the TC prediction 31. In other words, the decoder 10 may be configured to entropy decode the current transform coefficient using first contexts, in case of the prediction mode of the predetermined block 12 fulfilling the predetermined criterion, and using second contexts, in case of the prediction mode of the predetermined block 12 not fulfilling the predetermined criterion, wherein the first and second contexts coincide.

Further, as also described above, the decoder 10 corrects for each of the transform coefficients in set 28 the TC predictor (predicted value of the TC) 32 using the transform coefficient residual decoded for that TC from the data stream 12 so that the resulting, residual-corrected TC value, thus obtained, unless being the last TC in scan order 15 among set 28, serves as a basis for TC prediction 31 of a next transform coefficient within the set 28 in scan order as indicated by the feedback from adder of the decoder 10 to TC prediction 31 in FIG. 4. In other words, for example, the feedback loop from the adder of the decoder 10 to the TC prediction 31 is: initialized by prediction of a TC among the set 28 which is first in scan order 15 and once predicted, serves as a basis for prediction of the next TC; and concluded by prediction of a TC among the set 28 which is last in scan order 15 and thus by virtue of being the last in the scan order does not serve as a basis for prediction of the next TC. As an optional feature, for example, it might be that during the course of the feedback and the prediction, one or more TCs among the set 28 do not serve as a basis for the next TC, thus in such a case, previously decoded TCs among the set 28 may be used as a basis for predicting the next TC. Further, for example, it may be that adder of the decoder 10 performs a weighted addition operation.

It should be noted that, for example, prior to a reverse transformation 40, the decoded transform coefficient residual, which may be subjected to quantization as part of its encoding by a corresponding encoder, is subjected to a dequantization stage and the decoder 10 subsequently corrects the TC predictor 31 for the current TC among the set 28 using the dequantized transform coefficient residual, as described in the previous paragraph, so as to obtain a reconstructed transform coefficient for each of the TCs in the set 28. Further, according to embodiments, the block based decoder 10 may be configured to decode the transform 17 from the data stream 24 by use of a scan order and using dependent dequantization by switching among a set of quantizers depending on the parities of previously decoded transform coefficients. In other words, the decoder 10 might, for example, partition the set of quantizers into a first subset and a second subset, wherein the first subset and the second subsets are associated to opposing values of parities of the previously decoded TCs, and the decoder 10 might decode the transform 17 by switching or alternating between these subsets.

Remarkably, in the course of the TC prediction 31 for a current TC, the inputs to the NNs 29 have already passed a quantization stage while only the current TC's prediction residual quantized. By this measure, it is possible to train each NN 29ᵢ with taking into account the quantization of the preceding TCs and training may by successfully done even when the TCs within set 28 are quantized sequentially, i.e. one after another, for instance using RDOQ or TCQ. This may achieve an improved balance between distortion and bitrate since training may be made more reliable.

Finally, the decoder 10 subjects the transform 17 thus obtained to a reverse transformation 40 (i.e. an inverse of the transformation applied in the course of encoding the transform coefficients) so as to obtain the prediction residual in spatial domain, and corrects the predicted sample filling 18 using the prediction residual.

Hitherto the present application has described an embodiment where the transform coefficient prediction 31 is performed for a set 28 of transform coefficients which includes several successive TCs, namely a DC transform coefficient and transform coefficients having comparatively higher frequencies. However, the present application also relates to a block based decoder, additionally or alternatively to the block based decoder 10 described so far, which performs the transform coefficient prediction 31 for only one transform coefficient such as, for instance, the DC transform coefficient. As a result, in relation to this block based decoder 10, only a single TC predictor 32 may be derived as part of the prediction 31. For instance, it might be that this decoder is alternatively or additionally configured to derive more than one predictor 32. Even further, it might be that the above description is varied in that the decoder uses TC prediction 31 for a set 28 of more than one TC, wherein, however, the TC prediction 31 does not include any previously decoded TC of set 28. That is, in the latter case, the TC predictions 31 for the TCs within set 28 might be performed in parallel rather than sequentially as previously described. With respect to all other details, the details and explanations provided hereinabove with respect to the decoder 10 performing the TC prediction 31 for the set of TCs 28 sequentially, may by adopted individually or in combination. Therefore, these details and explanations are not repeated now for the sake of conciseness and brevity of the present disclosure.

The present disclosure proceeds henceforth with further details and explanations which are promptly combinable with both the decoder 10 suitable for prediction of a set of transform coefficients 28 and the decoder suitable for prediction of one, such as the DC TC, or more transform coefficients.

The above discussion concentrated on a certain block 12 which may have associated therewith one or more of the following characteristics such as:
a) size of block 12 such as x samples wide and y sample high, and
b) prediction mode such as a selected intra prediction mode in case of block 12 being an intra predicted block, or an inter prediction mode in which case one or more motion vectors might be signaled in the data stream 12 for block 12, and
c) the type of the transform or the type of the transformation leading to the transform in case of, for instance, decoder 10 supporting more than just one transform type for transforming the prediction residual, and
d) the quantization parameter based on which the transform has been quantized such as the quantization step size, and based on which the decoder dequantizes or scales the transform.

According to embodiments, the decoder 10 supports different block sizes for the predetermined block 12 and performs the decoding of the transform 17 of the prediction residual for the predetermined block 12 from the data stream 24 by varying one or more of a number of transform coefficients in the set of transform coefficients 28, a number of parameters defining the function, the parameters defining the function, depending on a size of the predetermined block 12. In other words, for example, the decoder 10 performs the decoding by selecting a size among the supported sizes for the predetermined block 12, and thus, varies TCs among the set 28 and parameters associated with function accordingly.

According to embodiments, the decoder 10 supports different transform types for the predetermined block 12 and varies one or more of 1) a number of transform coefficients in the set of transform coefficients 28, i.e. the count of TCs within set 28 or the set's cardinality, 2) a number of parameters defining the function, i.e. the count or number of attributes of the function, and 3) the parameters defining the function such as the weights of the NN implementing the function or offsets of the NN implementing the function or its number, or count, of layers, depending on a transform type of the predetermined block 12.

According to embodiments, the decoder 10 supports different intra prediction modes for the predetermined block 12 and varies one or more of 1) a number of transform coefficients in the set of transform coefficients 28, i.e. the count of TCs within set 28 or the set's cardinality, 2) a number of parameters defining the function, i.e. the count or number of attributes of the function, and 3) the parameters defining the function such as the weights of the NN implementing the function or offsets of the NN implementing the function or its number, or count, of layers, depending on a intra prediction mode of the predetermined block 12.

In this case, it may be that, with respect to the TC prediction 31, one or more of the following may be true:
1) the decoder 10 manages and comprises a set of NNs 29ᵢ (and possibly associated scalar product parameters 35ᵢ) for each block size or each of different groups of block sizes into which all supported block sizes are grouped, and the decoder 10, when performing the TC prediction 31, firstly selects the corresponding—the one fitting to the size of block 12—set of NNs 29ᵢ (and possibly associated scalar product parameters 35ᵢ) before acting and behaving as described above with respect to that set of NNs 29ᵢ (and possibly associated scalar product parameters 35ᵢ). That is, for instance, the decoder may select NNs 29ᵢ using a predetermined criterion which is associated with the supported block sizes of the block 12.
2) the decoder 10 uses (and possibly selects), for instance, the same set of NNs (and possibly associated scalar product parameters 35ᵢ) irrespective of the prediction mode of block 12, but it could, naturally, be that the decoder manages and comprises a set of NNs 29ᵢ (and possibly associated scalar product parameters 35ᵢ) for each intra-prediction mode or each of different groups of intra-prediction modes into which all supported intra-prediction mods are grouped, and the decoder 10, when performing the TC prediction 31, may firstly select the corresponding—the one fitting to the intra prediction mode of block 12—set of NNs (and possibly associated scalar product parameters 35ᵢ) before acting and behaving as described above with respect to that set of NNs (and possibly associated scalar product parameters 35ᵢ) such as by use of the index of the selected intra-prediction mode for block 12 which index might be signaled in the data stream.
3) the decoder 10 uses (and possibly selects), for instance, the same set of NNs (and possibly associated scalar product parameters 35ᵢ) irrespective of the transform type of block 12, but it could, naturally, be that the decoder 10 manages and comprises a set of NNs 29ᵢ (and possibly associated scalar product parameters 35ᵢ) for each transform type or each of different groups of transform types into which all supported transform types are grouped, and the decoder, when performing the TC prediction 31, may firstly select the corresponding—the one fitting to the transform type of block 12—set of NNs (and possibly associated scalar product parameters 35ᵢ) before acting and behaving as described above with respect to that set of NNs (and possibly associated scalar product parameters 35ᵢ).
4) Naturally, it may be that the decoder 10 applies TC prediction 31 only to a subset of the possible block characteristics a-d listed above, such as only to blocks in a certain range of sizes, blocks whose residual is of one or more of certain transform types, and blocks of one or more intra-prediction modes. Moreover, inter-predicted blocks may or may not be subject to TC prediction 31.

Note that in FIG. 4, the TC predictor 32 contribution or input into the adder is assumed to be zero for coefficients other than those in set 28. Equivalently, for instance, the TC prediction 31 may not be performed for transform coefficients not belonging to the set 28 and thus may be kept trivially zero. Further, for instance, the number of predictors 32, or derivable by a same measure the number of transform coefficients with non-zero values, may be variable depending on the block shape and the attributes of the NNs 29. For example, the number of predictors 32 may depend on the number of layers of the NNs 29 and/or the parameters and the number of parameters of the function i.e. the NNs 29 (the function being implemented as NNs 29, in this instance).

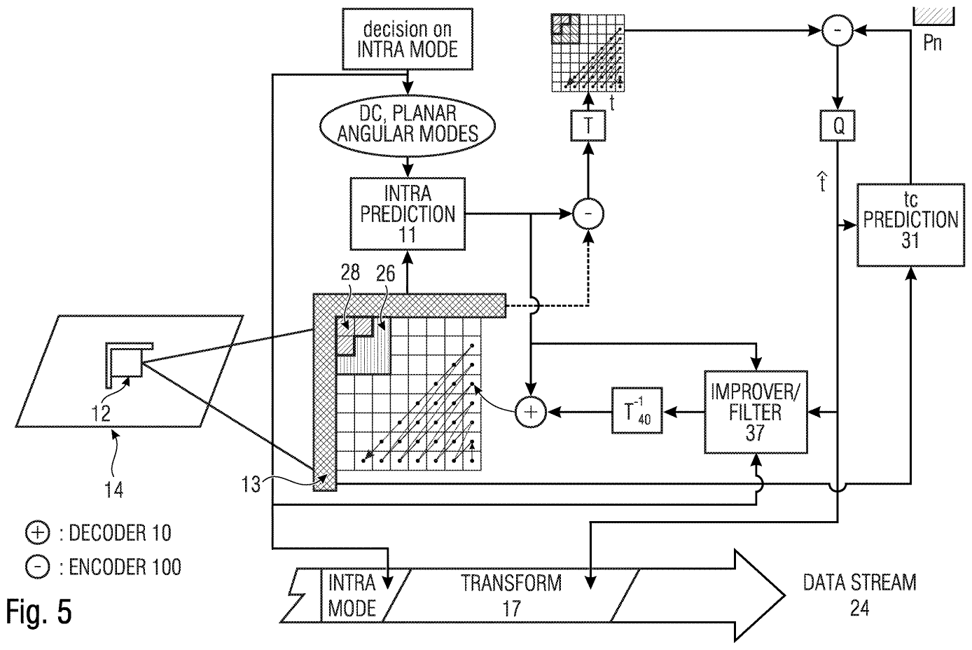

So far, an embodiment has been described where the decoder 10 does not make use of the improvement/filtering 37 of the transform. FIG. 4 illustrates the use of this improvement/filtering 37, but it should be clear that other than described now and shown in FIG. 4, alternative embodiments for decoder 10 may readily be derived by a decoder not configured to perform the TC prediction 31 described above with respect to 32 and FIG. 5 but configured to perform the transform improvement/filtering 37 described now and vice versa. In other words, embodiments exist, which are in accordance with feasible variations of FIG. 4 wherein: the decoder 10 does not use the improvement/filtering 37 of the transform 17, but does readily use the TC prediction 31; the decoder 10 does not use the TC prediction 31, but does readily use the improvement/filtering 37 of the transform 17; and the decoder 10 uses both the TC prediction 31 and the improvement/filtering 37. It should be understood that although not shown in FIG. 4, emphasis is additionally placed on alternative versions of FIG. 4 wherein the block 31 is absent while the block 37 is present and vice versa.

In particular, decoder 10, after having derived the transform 10 as described above (or without TC prediction 31), might improve the transform as follows: it computes an additive offset mask for the transform 17 using an improvement function attributes of which comprise the transform 17 to be improved, and the predicted sample filling 18. The improvement function might be a trained NN. For instance, the attributes of the improvement function may comprise the reconstructed transform coefficients of the transform 17. Further, for instance, the attributes of the improvement function may comprise previously decoded samples neighboring 13 the predetermined block 12. According to embodiments, the attributes of the improvement function may comprise a quantization parameter of the predetermined block 12. For example, the quantization parameter might be decoded by the decoder 10 from the data stream 24.

As will be described in further detail below, the filtering or improvement 37 by the improvement function, for example, may be implemented using a learning-based concept such as a neural network, which may optionally be trainable or trained, for instance using training data. Implementations of the improvement function may be based on either an intra-prediction mode among a plurality of intra-prediction modes, or a grouping of intra-prediction modes formed out of the plurality of intra-prediction modes. It is feasible that in the course of prediction 11 of the predicted sample filling 18 of the block 12, one or more intra-prediction modes may be selected from the plurality of the intra-prediction modes.

The improvement function may be implemented as one filter/improver stage or NN which is used for all of the plurality of intra-prediction modes, i.e. irrespective of which intra-prediction mode is selected for block 12. In such examples, this one filter/improver stage or NN may take as input, inter alia, the index of the selected intra-prediction mode(s) for the block 12 which may be signaled in the data stream 24. That is, the attributes of the improvement function may comprise the index of the selected intra-prediction mode(s). For example, in embodiments, there may be a single filtering/improver stage or NN implementing the improvement function which is used in case of the block's 12 intra prediction mode being the PLANAR intra-prediction mode, the DC intra-prediction mode, or any of the directional intra prediction modes. If also applied for MIP coded blocks, this stage or NN might even be involved in the improvement 37 in case of the block's mode being one of the MIP modes.

Additionally, or alternatively, the improvement 37 may be implemented as a plurality of filter/improver stage or NNs, wherein each of same may may be attributed to one or more of the intra-prediction modes. In other words, here, each of the intra-prediction modes or at least each of the intra-prediction modes qualified to be subject to the usage of the filtering/improvement 37, is associated with one of the filtering/improvement stages or NNs, with more than one such filtering/improvement stages or NNs being available. For example, in accordance with embodiments, there may be z stages or NNs, one relating to, or used in improvement 37, when the block 12 is of the PLANAR intra-prediction mode, one relating to the DC intra-prediction mode, and z−2 relating to different subsets of, or relating individually to each of, the angular modes. That is, for sake of the filtering/improvement 37, firstly the stage or NN to be used would be selected based on the intra prediction index associated with block 12, wherein the index would be mapped onto one of the z-2 stages or NNs in case of the block's intra prediction mode being an angular prediction mode, wherein this mapping may implement a kind of “quantization” of the angular direction signaled by the intra prediction mode so that each of the z-2 stages or NNs would be associated with a contiguous set of signalable intra prediction directions, and then the selected stage of NN would be used to improve the transform 17. A further variation could be that one stage or NN is used for both the DC and the planar mode, thereby ending up into z-1 stages or NNs. Further, z may be chosen to be an integer within 2<z≤N+2, wherein N is the number of directional modes in case of using separate stages or NNs for DC and PLANAR, and an integer within 1<z≤N+1, wherein N is the number of directional modes in case of using a common stage or NN for DC and PLANAR.

For example, in accordance with embodiments, there may be z stages or NNs, one relating to, or used in improvement 37, when the block 12 is of the PLANAR intra-prediction mode, one relating to the DC intra-prediction mode, s relating to different subsets of, or relating individually to each of, the angular modes and z-s-2 relating, or used in improvement 37, to different subsets of, or relating individually to each of, the matrix-based intra prediction, MIP, modes. That is, for sake of the filtering/improvement 37, firstly the stage or NN to be used would be selected based on the intra prediction index associated with block 12, wherein the index would be mapped onto one of the z-s-2 stages or NNs in case of the block's intra prediction mode being a MIP mode, wherein this mapping may implement a selection of a matrix (given a vector) which is signaled by the intra prediction mode so that each of the z-s-2 stages or NNs would be associated with a contiguous set of signalable intra prediction matrices, and further the stage or NN to be used would be selected based on the then the selected stage of NN would be used to improve the transform 17. A further variation could be that one stage or NN is used for both the DC and the planar mode, thereby ending up into z-s-1 stages or NNs. Further, z may be chosen to be an integer within M+2<z≤N+M+2, wherein N is the number, or count, of MIPs modes in case of using separate stages or NNs for DC and PLANAR and angular modes, a number or count of which is denoted by M, and an integer within M+1<z≤N+M+1, wherein N is the number of directional modes in case of using a common stage or NN for DC and PLANAR but still separate stages for angular modes, a number or count of which is denoted by M.

It is also noted that variations of the described implementations also exist wherein the stages or NNs relating to the filter/improver 37 may be present for some of the intra-prediction modes while the stages or NNs relating to the filter/improver 37 may be absent for some other of the intra-prediction modes. In particular, for the latter modes, the inputs, namely the transform 17 to be improved and the predicted sample filling 18, are applied in a transposed manner, in a manner corresponding to a mirroring same at the diagonal leading from top left to bottom right corner (or possibly, for example, from top right to bottom left corner), to the stage or NN attributed to the intra prediction mode corresponding to the intra prediction direction resulting when mirroring the intra prediction direction of any of the latter modes at the just-mentioned diagonal(s), and transposing, again, the additive mask obtained by the subsequently used stage or NN.

For example, in case of the predetermined block 12 being a square block, w stages or NNs of the filtering/improvement 37 may be present for this block size and shape, with these w stages or NNs relating to different subsets of, or relating individually to each of, those angular modes for which the associated intra prediction directions are all above or equal to, or all below or equal to, the diagonal direction along the top left to bottom right of the square block. For instance, these angular modes may have a mode index smaller than a predetermined index (e.g., MODE_IDX=<DIAG_IDX) (or for instance, alternatively, larger than this index), with the predetermined mode index DIAG_IDY corresponding to the mode whose intra prediction direction leads along the diagonal, whereas there are no stages or NNs of the filtering/improvement 37 for the other modes, such as modes having a mode index larger than the predetermined index (for instance, MODE_IDX>DIAG_IDX) (or smaller than this index). This means that the filter/improver stages, or NNᵢs, might be present for some angular modes and absent for corresponding diagonally mirrored angular modes. For instance, the diagonal mode index DIAG_IDX may be 34 in VVC. The present w stages, or NNs would then be used, or applied, for the angular modes for which no now filter/improver stage or NNᵢs present, in the following manner:
The mode's intra prediction direction is mirrored at the diagonal. The stage or NN attributed with the mode associated with the resulting intra prediction direction is selected out of the existing ψ stages, or NNs
inputs of the selected stage, or NN are transposed, i.e. horizontal and vertical axis of the transform block 17 and the predicted sample filling 18, respectively, may be permuted;
the additive offset mask obtained by use of the selected stage or NN may be transposed again by permuting horizontal and vertical axis of the offset mask.

Further, w may be chosen to be an integer within 2<ψ≤(N+1)/2, wherein N is the number, or count, of angular modes (assuming that N is uneven and the N angular modes having intra prediction directions symmetrically distributed with respect to the diagonal and including the diagonal direction, in case of using separate stages or NNs for DC and PLANAR and angular modes and, and an integer within 1<ψ≤(N+1)/2, wherein N is the number of angular modes in case of using a common stage or NN for DC and PLANAR.

In accordance with embodiments, each of the stages may be a NN and as to the NN implementation, each neural network may comprise an initial non-linear fully-connected layer and one or more succeeding layers. The non-linear quality of the initial layer of the neural network may be due to its non-linear dependency on inputs of the NN to which it is connected, whereas the fully-connected quality of the initial layer may relate to every input of the initial layer being connected to every input of a layer (or, for instance, layers) immediately succeeding the initial layer such as any among the one or more succeeding layers. By this measure, the initial layer of the NN provides, for instance, a complete linkage between the initial layer and the one or more succeeding layers. The neural network may receive the transform 17, the predicted sample filling 18 and the index of the selected intra-prediction modes as inputs of the initial layer. The neural network may further receive an output of the initial layer as an input of the one or more succeeding layers, and perform an inference based on the transform 17 and the predicted sample filling 18. The decoder 10 computes the additive offset mask using this neural network designed for the intra-prediction mode among the plurality of intra-prediction modes, or the grouping of intra-prediction modes formed out of the plurality of intra-prediction modes.

It is noted, for instance, that the improvement function may be implemented using any non-linear function. In accordance with embodiments, the improvement function may be non-linear with respect to the transform 17 (or the transforms, when more than one transforms are supported), the predicted sample filling 18 (and varying characteristics thereof such as size) and the index of the selected intra-prediction mode.

Possibly, according to embodiments, the final layer of the one or more succeeding layers of the neural network may be a linear layer. It is to be understood that linearity of the final layer relates to the attributes, or inputs, of the neural network implementing the improvement function such as the transform 17, the predicted sample filling 18 and the index of the selected intra-prediction mode. For instance, the NN implementing the improvement function may have additional attributes such as parameters associated with quantization, for example a quantization parameter, a total number of layers, parameters associated with block size of the predetermined block 12. Nevertheless, additional or alternative attributes are feasible.

Further, it may be that, with respect to the filtering/improvement 37, one or more of the following may be true:
1) the decoder manages and comprises a NN for the improvement 37 for each block size or each of different groups of block sizes into which all supported block sizes are grouped, and the decoder, when performing the improvement 37, firstly selects the corresponding—the one fitting to the size of block 12-NN before acting and behaving as described above, namely applying the NN onto the (yet unimproved) transform and the filling 18. Note that the grouping of the blocks may group mutually transposed blocks, i.e. blocks and correspondingly transposed blocks comprising the same size, together. In other words, blocks of shape W×H and H×W, may be grouped together, where W and H denote dimensions of the block, e.g. with W being the width of one block in samples and H being the height of this block in samples. Without loss of generality, in case of the block shape W×H, the filter/improver NN would process its inputs and outputs without additional operations whereas in case of the transposed block shape H×W, the inputs, namely the transform block and the predicted sample filling 18 (i.e. the prediction signal) would be transposed before application onto the NN, thereby allowing the filtering/improvement 37 by the NN for the block shape W×H to be used, and subsequently, the output of the NN would be transposed back into the shape H×W thus obtaining the additive offset mask for the transposed block shape H×W.
2) the decoder manages and comprises a NN for the improvement 37 for each intra-prediction mode or each of different groups of intra-prediction modes into which all supported intra-prediction mods are grouped, and the decoder, when performing the TC prediction 31, may firstly select the corresponding—the one fitting to the intra prediction mode of block 12—set of NNs (and possibly associated scalar product parameters 35ᵢ) before acting and behaving as described above with respect to that set of NNs (and possibly associated scalar product parameters 35ᵢ) such as by use of the index of the selected intra-prediction mode for block 12 which index might be signaled in the data stream. For example, in embodiments, the decoder 10 may decode the index of the selected intra-prediction mode from the data stream 24.
3) the decoder 10 manages and comprises a NNs for the improvement 37 for each transform type or each of different groups of transform types into which all supported transform types are grouped, and the decoder 10, when performing the TC prediction 31, may firstly select the corresponding—the one fitting to the transform type of block 12—set of NNs (and possibly associated scalar product parameters 35ᵢ) before acting and behaving as described above with respect to that set of NNs (and possibly associated scalar product parameters 35ᵢ).
4) the decoder 10 manages and comprises a NNs for the improvement 37 for each QP or each of different groups of QPs into which all supported transform types are grouped, and the decoder 10, when performing the TC prediction 31, may firstly select the corresponding—the one fitting to the QP of block 12—set of NNs (and possibly associated scalar product parameters 35ᵢ) before acting and behaving as described above with respect to that set of NNs (and possibly associated scalar product parameters 35ᵢ).
5) Naturally, it may be that the decoder 10 applies improvement 37 only to a subset of the possible block characteristics a-d listed above, such as only to blocks in a certain range of sizes, blocks whose residual is of one or more of certain transform types, and blocks of one or more intra-prediction modes. Moreover, inter-predicted blocks may or may not be subject to TC prediction 31.

Describing in more generality what has already been described, according to embodiments, the block based decoder 10 may have the improvement function implemented by a neural network, and the block based decoder 10 may be configured to support one or more of a number of different block sizes for the predetermined block 12, and compute the additive offset mask by selecting and using a neural network, which is associated with a size of the predetermined block 12.

Describing in more generality what has already been described, according to embodiments, the block based decoder 10 may have the improvement function implemented by a neural network, and the block based decoder 10 may be configured to support one or more of a number of different transform types for the predetermined block 12, and compute the additive offset mask by selecting and using a neural network, which is associated with a transform type of the predetermined block 12.

Describing in more generality what has already been described, according to embodiments, the block based decoder 10 may have the improvement function implemented by a neural network, and the block based decoder 10 may be configured to support one or more of a number of different block sizes for the predetermined block, and compute the additive offset mask by selecting and using a neural network, which is associated with a size of the predetermined block, wherein, for if the size exceeds a predetermined size limit, the neural network takes, as an input, merely a sub-portion of the transform.

Naturally, it might be that at least some of the characteristics discussed above are not used for selecting the improvement NN, but used as another input for a common NN trained for the different possible settings this/these one or more characteristic may assume.

It should also be noted that the above discussion may further be varied with respect to the following: the number of TCs in set 28 might be 2 or more—maybe depending on block size—but may also be one, either for one or more block sizes, while the cardinality of set 28 is larger than one for other block sizes, or the decoder is inevitably only configured to only predict one of the TCs in the transform 17, i.e. there is only one TC in set 28 for whatever block subject to TC prediction 31. Moreover, related thereto, it might be that the function underlying TC prediction does not involve the dependency on any other TC of set 28.

It should also be noted that the embodiments of the present disclosure may comprise, where the prediction residual stems from using either intra-picture or inter-picture prediction. In particular, the neural network may be designed specifically for coding the transform coefficients of inter-predicted residual. In the present disclosure, the tested All-Intra configuration and the networks are optimized for PLANAR intra prediction. Additionally, this may be done for inter-predicted residual. Moreover, the networks, or variations of, may comprise variations in the number of parameters and the parameters themselves depending on the transform type, block size and the type of motion-compensated prediction.

Furthermore, according to the embodiment in the present disclosure the filter or improver in may also improve the transform in the case of, but not limiting to, the predicted sample filling stems from motion compensation. In this case, the indices of the selected intra-prediction mode and additional information characterizing the motion compensation may be used as input.

The embodiments of the present disclosure include the case when a transform coefficient from the set of transform coefficients 28 is predicted using the previously decoded ones from this set and/or the case when a transform coefficient from the set of transform coefficients is predicted from the same number of further transform coefficients 26 at the same positions. Among other things, it covers even the case when only the further transform coefficients 26 are used.

The embodiments of the present disclosure comprise the case where the number of transform coefficients in the set of transform coefficients 28 is three or more.

The embodiments of the present disclosure comprise both the coefficient prediction and the coefficient filter agnostically to the choice of the intra prediction mode and the transform type. This implies, for example, that in some cases the coefficient prediction and the coefficient filter may operate independently of the intra prediction mode and the transform type and that in some other cases the coefficient prediction and the coefficient filter may operate depending on the choice of the intra prediction mode and the transform type. Such predictors and filters may be designed for any transform type and intra prediction mode, provided, but not only limiting to, suitable training data is available. The implementation presented in Section IV can be considered a proof of concept, but there is no reason why one may restrict these new coding tools to transform types such as the DCT and DST and the intra-prediction modes such as PLANAR, DC, ANGULAR, MIP and ISP modes.

Furthermore, the embodiment of the present disclosure comprises the possibility of using transforms other than DCT or DST as transform domain for the prediction residual. Such other transforms comprise any types of transforms such as sparsifying data-trained orthogonal transforms which ease the computation of rate distortion and lead to high energy compaction. The scan order leads from the transform coefficient which, on average, comprises lowest energy, to the transform coefficient which, on average, is of largest energy.

FIG. 5 shows an encoder 100 fitting to the decoder 10 of FIG. 4.

It is particularly emphasized that details and explanations pertaining to embodiments, possibilities and alternatives disclosed herein corresponding to the decoder 10 of FIG. 4 are promptly transferable to the encoder 100, as depicted in FIG. 5, with suitable adjustments and modifications. In other words, the encoder 100 of FIG. 5 is based upon the same coding concepts (which has already been described in detail) and considerations thereof as the decoder 10 of FIG. 4. For the sake of brevity and conciseness of this disclosure, the present application proceeds further without furnishing a repetition of details of the coding concepts in forms as applicable to the encoder 100. Rather, some examples of such details as transferred to the encoder 100 are summarily described in the succeeding paragraphs.

FIG. 5 shows an embodiment of a block based encoder 100. The encoder 100 may be a video encoder or a picture encoder which, in addition to the details set out with respect to FIG. 5, comprises one or more of the functionalities described above with respect to FIGS. 1 to 4.

The encoder 100 predicts 31 a predicted sample filling 18 of the predetermined block 12 using a intra-prediction mode which the encoder 100 encodes into the data stream 24, such as encoding an index of the intra-prediction mode into the data stream 24. In particular, the predicted sample filling 18 of the predetermined block 12 might be predicted by selecting an intra-prediction mode out of a plurality of intra-prediction modes which the encoder 100 supports. The encoder 10 might support further intra-prediction modes or fewer or a different collection. The predicted sample filling 18 is generated using the selected intra-prediction mode based on values of already encoded samples in a neighborhood 13 of the predetermined block 12. Again, FIG. 5 illustrates concepts of encoder 100 with respect to an intra-predicted block, although these concepts would be readily transferable onto inter-predicted blocks, so as to be configured to apply these concepts onto such inter-predicted block alternatively or additionally.

The encoder 100 further encodes a transform 17 of a prediction residual for the predetermined block 12 into the data stream 24 using which the predicted filling 18 is finally corrected. The encoder 100 applies the transform 17 by sequentially encoding a set of transform coefficients 28 along a scan order 15 which, for instance, leads from a transform coefficient having, expectationally, lowest energy such as a highest frequency transform coefficient towards the transform coefficient having, expectationally, highest energy such as a lowest, or zero, frequency transform coefficient. The scan order 15 might lead, for instance, diagonally from highest frequency transform coefficient to DC coefficient.

There are different transform coefficients of transform 17 in the example of FIG. 5, wherein the coefficients are drawn in FIG. 5 by small squares, or differently, the encoder 100 behaves differently with respect to different ones of these transform coefficients: for set 28 of transform coefficients which may include the one at the end of scan order 15, for instance, the encoder 10 performs a TC prediction 31 discussed in more detail below, with encoding into the data stream 24 only a TC residual for the respective TC, while encoding the TC completely or unpredicted into the data stream 24, or without TC prediction 31, with respect to other TCs not in set 28. In predicting TCs in set 28, some TCs, here denoted as 26, serve as a prediction basis, while there may be, optionally, and maybe depending on the size of block 12 and transform 17, respectively, TCs 27 which do not serve a prediction basis for TC prediction 31 and which are also not predicted.

The encoder 100 encodes a transform coefficient residual for the current TC among the set 28 into the data stream 24. The current TC is corrected using this TC residual, which can then be used to predict a next TC among the set 28, if the current TC is not lastly encoded among the set 28.

FIG. 5 also depicts the encoder 100 making use of the improvement/filtering 37 of the transform 17. The encoder 100 encodes a transform 17 of a prediction residual for the predetermined block into the data stream 24, which may be a part of a rate-distortion optimizer or a part of a prediction loop of the block based encoder 100 or a part of both. The encoder 100 improves 37 the transform 17 by computing an additive offset mask using an improvement function. The attributes of the improvement function comprise the transform 17 and the predicted sample filling 18. The encoder 100 further subjects the transform 17 to a reverse transformation and finally corrects the predicted sample filling 18 using the prediction residual.

Further, the encoder 100 might select a selected intra-prediction mode out of a plurality of intra-prediction modes and predict 11 the predicted sample filling 18 using the selected intra-prediction mode, and thus, the attributes of the improvement function may also comprise an index of the selected intra-prediction mode. It is also feasible that the attributes of the improvement function may additionally comprise a quantization parameter, QP, of the predetermined block 12.

In accordance with embodiments, the improvement function may be non-linear with respect to the transform 17, the predicted sample filling 18 and the index of the selected intra-prediction mode.

In accordance with embodiments, implementations of the improvement function may comprise, for example, a neural network, adapted for each of the plurality of intra-prediction modes or any groupings thereof, comprising an initial non-linear fully connected layer and one or more succeeding layers. This neural network may receive the transform 17, the predicted sample filling 18 and the index of the selected intra-prediction mode as inputs of the initial layer, and additionally may receive an output of the initial layer as an input of the one or more succeeding layers. The neural network then performs an inference based on the transform 17 and the predicted sample filling 18. The encoder 100 uses the neural network and thus, computes the additive offset mask.

The improvement function may be implemented as one filter/improver stage or NN which is used for all of the plurality of intra-prediction modes, i.e., irrespective of which intra-prediction mode is selected for block 12. In such examples, this one filter/improver stage or NN may take as input, inter alia, the index of the selected intra-prediction mode(s) for the block 12 which may be signaled in the data stream 24 (e.g. encoded into the data stream 24). That is, the attributes of the improvement function may comprise the index of the selected intra-prediction mode(s).

Additionally, or alternatively, the improvement 37 may be implemented as a plurality of filter/improver stage or NNs, wherein each of same may may be attributed to one or more of the intra-prediction modes. In other words, here, each of the intra-prediction modes or at least each of the intra-prediction modes qualified to be subject to the usage of the filtering/improvement 37, is associated with one of the filtering/improvement stages or NNs, with more than one such filtering/improvement stages or NNs being available.

It is emphasised that the encoder 100 described herein may comprise any of the aspects described earlier in the disclosure either in combination as combined embodiments or taken individually as separate embodiments. That is, the encoder 100 supports, for instance, at least one of: prediction 31 of a set of transform coefficients using the function, prediction 31 of a one transform coefficient, e.g. DC coefficient, or more TCs using the function, and block-wise filtering 37 of transform coefficients using the improvement function. It follows then that the encoder 100 also supports combinations of the described functionalities such as prediction 31 of a set of transform coefficients along with block-wise filtering 37 of the transform coefficients, and prediction of a transform coefficient along with block-wise filtering of the transform coefficients. Naturally, the encoder may also support features such as TC prediction 31 for transform coefficients and filtering/improvement 37 of transform coefficients in a standalone manner. This means that variations of FIG. 5, wherein one or more blocks pertaining to filtering/improvement 37 are absent while one or more blocks pertaining to TC prediction 31 are present, and wherein one or more blocks pertaining to filtering/improvement 37 are present while one or more blocks pertaining to TC prediction 31 are absent, exist.

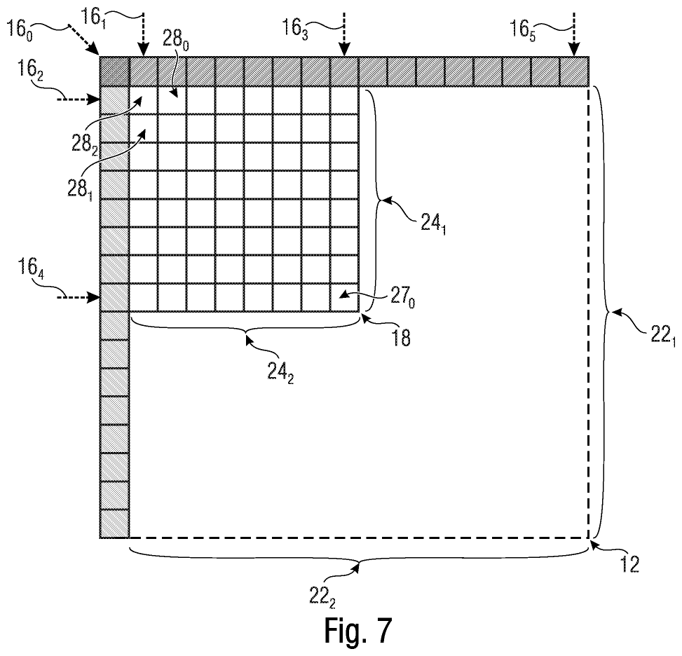

FIG. 7 depicts a schematic representation of an example of the predicted sample filling 18 of the predetermined block 12. Features described below may be combined individually or in combination with one or more functionalities described by FIGS. 1 to 6 so far.

The predetermined block 12 has a first extension 22₁ (e.g. a width) along a first direction and a second extension 22₂ (e.g. a height) along a second direction, wherein the first direction and the second direction are perpendicular to each other. The predicted sample filling 18, which forms an upper left sub-block of the predetermined block 12, has a first extension 24₁ (e.g. a width) along the first direction and a second extension 24₂ (e.g. a height) along the second direction. For example, the predicted sample filling 18, as shown in FIG. 7, has a block size four times smaller than that of the predetermined block 12. Thus, for instance, the sample filling 18 may have the width 24₁ which can be denoted by W and the height 24₂ which can be denoted by H while the block 12 may have the width 22₁ which can be denoted by 2W and the height 22₂ which can be denoted by 2H.

For example, the width 24₁ and the height 24₂ may be equal to each other. For example, the sample filling may be a 8×8 block, that is, W=H=8.

As shown in FIG. 7, samples 16 are in a neighbourhood 13 of the predetermined block 12. The samples 16, each 16; of which is depicted by a small square, directly abut part of the circumference, or perimeter, of the predicted sample filling 18. As optionally shown, the samples 16 are located along the first direction of the predetermined block 12, that is, a horizontal direction and along the second direction of the predetermined block 12, that is, a vertical direction.

The samples 16 may also be referred to as reference samples and may be denoted by a notation r [i][j], wherein the index i corresponds to the horizontal direction and the index j corresponds to the vertical direction. Thus, it follows that the reference sample 160 in the upper left corner of the predetermined block 12 may be denoted by r [−1][−1], the reference sample 161 may be denoted by r [0][−1], the reference sample 163 may be denoted by r [W−1][−1], the reference sample 165 may be denoted by r [2W−1][−1], the reference sample 162 may be denoted by r [−1][0] and the reference sample 164 may be denoted by r [−1][H−1].

The transform coefficients 28₀, 28₁, 28₂ of the set 28 of predicted TCs are shown in the upper left corner of the predicted sample filling 18 adjacent to the samples 16. The transform coefficients in addition to the ones in set 28, that is, the further TCs 26 and the even further TCs 27 are together denoted by the small squares of the predicted sample filling 18. In particular, the TC 27₀ in the lower right corner is to be decoded first in accordance with the scan order 15 which runs from the TC having lowest energy towards the TC having the highest energy.

The present application now proceeds with a description of the concepts described herein using mathematical equations and coding information as examples of possible implementations.

For example, in accordance with FIG. 7, given a luma block x of shape W×H with reference samples 16, r∈ [symbol] ^{2(W+H)+1} let P(r)∈ [symbol] ^{WH} denote the intra prediction signal 18 and T: [symbol] ^{WH}→ [symbol] ^{WH} denote an arbitrary orthogonal block transform 17. That is, the luma block may be an unpredicted sample filling, to which, for instance intra prediction, is applied to form the predicted sample filling 18.

As shown in FIG. 7, the transform coefficients sorted in a scan order, which runs in an opposite manner to the scan order 15 described previously with respect to embodiments, can be written as:

$$t = ( {t}_{0} , {t}_{1} , … , {t}_{W H - 1} ) = T ( x - P ( r ) ) , \qquad ( 1 )$$

$$\hat{t} = ( {\hat{t}}_{0} , {\hat{t}}_{1} , … , {\hat{t}}_{W H - 1} ) = DQ ∘ Q ( t ) , \qquad ( 2 )$$

where \hat{t} are the reconstructed coefficients after quantization Q and dequantization DQ.

It is relevant to note that the TC 28₂ of the set 28 of predicted TCs corresponds to t₀, that is the TC sorted as first as per the scan order of the previous paragraph while it is en/decoded lastly among the set 28 as per the scan order 15. It follows then that the TC 28₁ corresponds to t₁, the TC 28₀ corresponds to t₂, and the TC 27₀ corresponds to t_{WH-1}, which is the last TC when sorted as per the scan order of the previous paragraph. Thus, the notation followed by equations in the present disclosure represent an optional example of a scan order different in comparison to the scan order 15 described previously.

In the following sections, an example is provided of how these coefficients might be processed by neural networks in accordance with the above presented concepts.

### I. Nonlinear Sequential Coefficient Prediction

For example, the quantized transform coefficients of a single block (e.g. the predicted sample filling 18), as denoted by equation 2, are coded sequentially in reverse scan order, i.e. the scan order 15, from high- to low-frequency components. For instance, this may be carried out in existing frameworks such as VVC. When \hat{t}ₙ is parsed, all previous coefficients in reverse scan order and the reference samples, i.e. the samples 16, can be reconstructed already. Hence, the nonlinear coefficient prediction 31 providing the predictor 32 pₙ can be defined as

$${p}_{n} := U ( ( ( {\hat{t}}_{n + 1} , … , {\hat{t}}_{W H - 1} ) , r ) ; θ ) + 〈 β , ( {\hat{t}}_{n + 1} , … , {\hat{t}}_{W H - 1} ) 〉 . \qquad ( 3 )$$

For instance, the network U, e.g. an implementation of the function as NN 29, with parameters θ may comprise two fully-connected layers with ReLU activation and a final linear layer while the second term in equation # is a linear regression with parameters. It is to be noted that equation (3) may be designed, for instance, to only depend on the preceding coefficients in reverse scan order 15 that lie inside an upper-left sub-block of the entire block 12 and on the W+H+1 direct boundary samples 16.

For example, for each block shape, e.g. or block size of block 12, the number N of predictors 32 p₀, . . . , p_{N-1}, the sub-block shape (e.g. or block size of filling 18), the size of the hidden layers in U and the computational complexity is given in Table 1. For instance, the complexity is stated in terms of carried out multiplications divided by the number of samples in the block 12.

TABLE I
NUMBER OF COEFFICIENT PREDICTORS, SUB-
BLOCK SHAPES, HIDDEN LAYER SIZE AND
NUMBER OF MULTIPLICATIONS PER SAMPLE.

| Block shapes | N | Sub-block shape | Hid. size | Mult./sample |
|---|---|---|---|---|
| 4 × 4 | 3 | 4 × 4 | 40 | 491.5 |
| 4 × 8, 8 × 4 | 3 | 4 × 4 | 60 | 502.1 |
| 8 × 8 | 3 | 4 × 4 | 80 | 424.5 |
| 4 × 16, 16 × 4 | 3 | 4 × 8, 8 × 4 | 80 | 500.3 |
| 16 × 16 | 6 | 8 × 8 | 120 | 611.8 |
| 8 × 16, 16 × 8 | 6 | 8 × 8 | 120 | 1178.6 |
| 8 × 32, 32 × 8 | 6 | 8 × 16, 16 × 8 | 120 | 815.8 |
| 16 × 32, 32 × 16 | 6 | 16 × 16 | 120 | 600.7 |
| 32 × 32 | 6 | 16 × 16 | 120 | 311.6 |
| 64 × 64 | 6 | 16 × 16 | 120 | 89.1 |

For instance, at the encoder side such as the encoder 100, the differences tₙ-pₙ, that is the transform prediction residual, is quantized instead of the original transform coefficients. If nº>ºN, the prediction 32 is set to zero. The reconstructed coefficients at the decoder such as the encoder 10, for instance, may be then derived as

$${\hat{t}}_{n} := DQ ∘ Q ( {t}_{n} - {p}_{n} ) + {p}_{n} . \qquad ( 4 )$$

For example, it is noted that modifying the input of the predictor 32, which for instance is given by equation (3), only affects the quantization decision of the current transform coefficient. Hence, for example, when t is quantized sequentially as in RDOQ or TCQ, the impact of equation (4) on both the distortion and the bitrate can be computed correctly for any input at the quantization stage.

### II. Nonlinear Block-Wise Coefficient Filtering

For example, at the decoder side such as the decoder 10, when a block of transform coefficients may be reconstructed, the corresponding prediction signal (e.g. the predicted sample filling 18) can be reconstructed too. Furthermore, the quantization parameter, QP, and the intra decision may be available. This motivates the design of a non-linear block-wise coefficient filter 37 which, for example, may be applied after reconstructing the transform coefficients. For example, in contrast to the nonlinear coefficient prediction 31 described before, the output of this network may not be a scalar but an offset which may be added to the transform block right before the inverse transform. Thus, for example, the nonlinear block-wise coefficient filter 37, denoted by f, is defined as:

$$f := V ( ( \hat{t} , P ( r ) , QP , intraMode ) ; ϕ ) . \qquad ( 5 )$$

For instance, here the network V with parameter φ may comprise of four fully connected layers with ReLU activation and a final linear layer, wherein intramode is the mode index of the intra prediction. For instance, for each block shape (e.g. block size of block 12) and each defined group of intra modes (for example, PLANAR, DC, 65 angular modes divided into five groups, MIP modes), a different filter can be trained. In the described implementations herein, a different filter has been trained.

Furthermore, for instance, equation (5) may be designed to only depend on the upper left min(16, W)×min(16, H) sub-block in the transform domain to constrain the complexity. As an optional example, the size of the hidden layers in V is given in Table II and chosen such that the number of necessary multiplications per sample is approximately the same for shapes smaller than or equal to 16×16.

TABLE II
HIDDEN LAYER SIZE OF THE COEFFICIENT FILTER
AND NUMBER OF MULTIPLICATIONS PER SAMPLE.

| Block shapes | Hidden size | Mult./sample |
|---|---|---|
| 4 × 4 | 120 | 3091.0 |
| 4 × 8, 8 × 4 | 170 | 3262.0 |
| 8 × 8, 4 × 16, 16 × 4 | 220 | 2999.6 |
| 8 × 16, 16 × 8 | 290 | 2973.6 |
| 16 × 16 | 370 | 2973.2 |
| 8 × 32, 32 × 8 | 370 | 2411.2 |
| 16 × 32, 32 × 16 | 370 | 1671.6 |
| 32 × 32 | 370 | 1020.8 |
| 64 × 64 | 370 | 532.7 |

For example, analogously to equation (1), the reconstruction at the decoder side such as the decoder 10 may be defined as

$$\hat{x} := {T}^{- 1} ( \hat{t} + f ) + P ( r ) . \qquad ( 6 )$$

For example, in contrast to networks with respect to the nonlinear transform coefficient prediction 31, the inputs of the network specified by (5) are part of the reconstruction. When either the transform coefficients or the prediction 31 may be altered, the impact of f in equation (6) on the distortion may have to be considered correctly at the encoder such as the encoder 100.

For example, when the final coefficient of a transform block to is quantized, TCQ may compare different input paths of reconstructed coefficients \hat{t}₁, . . . , \hat{t}_{WH-1} by testing two or more possible quantization indices per input path. For instance, the Viterbi algorithm may then determine the best candidate among all possible paths in terms of the rate-distortion cost. At this stage of the quantization, a nonlinear network, such as any implementable by the improvement function, may manipulate reconstructed transform coefficients as long as the quantizer decision remains fixed and the impact on the distortion is computed correctly.

### III. Training Details

In the following, an optional example relating to training the neural networks described in Sections I and II is presented with respect to the concepts of the present application. Other possible implementations and alternatives are wholly feasible.

For example, for the training of both networks, the BVI-DVC database for deep video compression [25] has been coded using VTM [26] in All-Intra configuration [27] with, for instance, QP values 22, 27, 32 and 37. For instance, after the encoding process, the original samples, transform coefficients, quantized coefficients, reference samples and the intra prediction of each block (e.g. the predetermined block 12) are collected. For instance, let X denote the entire dataset as

$$𝒳 := \{ {( x , t , \hat{t} , r , P ( r ) , QP , intraMode )}_{i} \vert i = 0 , 1 , 2 , … \} .$$

For instance, for the coefficient prediction 31, according to equation (3), the training objective may be to minimize the prediction error in the transform domain as follows

$${min}_{θ , β} {𝔼}_{𝒳} [ \vert {t}_{n} - {p}_{n} ( ( {\hat{t}}_{n + 1} , … , {\hat{t}}_{W H - 1} , r ) , ( θ , β ) ) \vert ] .$$

For instance, the motivation behind using the absolute error rather than the squared error is that the quantized transform coefficients are entropy coded assuming a Laplacian-like distribution for the unquantized coefficients [10]-[2]. Hence, for example, when the absolute error decreases at the training stage, the differences tₙ−pₙ should be distributed tighter around zero and less expensive to encode than the original coefficients tₙ. For example, regarding the coefficient filter network 37 specified by equation (5), since the quantization decisions may stay fixed, the reconstruction quality may be increased as follows

$${min}_{ϕ} {𝔼}_{𝒳} [ MSE ( t , \hat{t} + f ( ( \hat{t} , P ( r ) , QP , intraMode ) ; ϕ ) ) ] ,$$

where MSE denotes the mean squared error.

For instance, for each block shape (e.g. or block size of block 12), the training data may comprise up to 10⁵ batches, wherein each batch may comprise 1024 examples. For instance, the coefficient prediction 31 and the filter 37 can be optimized using the same database but distinctly from one another. For example, for the optimization, stochastic gradient descent using the Adam optimizer with a fixed learning rate 10⁻⁴ may be performed [28]. For instance, the training may be stopped whenever the loss saturates or the number of epochs exceeds 50.

### IV. Implementation Details

For example, the networks from Sections I and II may be implemented into VTM-14.2 [22] as luma-only tools as follows. For example, for each block shape stated in Table I, the coefficient prediction networks 31 are optimized for the PLANAR intra mode only. For example, furthermore, two distinct sets of networks are optimized: one set for the DCT-II transform and the other set for the DST-VII. Hence, for example, the coefficient prediction 31 may be disallowed, or e.g. suppressed, for blocks not using the PLANAR with one of the aforementioned transforms. Conversely, for example, it may be enforced for all supported blocks that use the PLANAR intra mode in combination with these transforms. For example, at the encoder side such as the encoder 100, TCQ may correctly regard the rate-distortion-cost of quantizing tₙ−pₙ. For instance, this may include the distortion caused by the quantization error

$${( {t}_{n} - ( DQ ∘ Q ( {t}_{n} - {p}_{n} ) + {p}_{n} ) )}^{2} ,$$

and the expected bitrate of coding Q (tₙ−pₙ).

For example, the coefficient filter networks 37 are optimized for the same block shape, but for multiple intra modes. For example, for the PLANAR, DC, each MIP mode and the directional modes (divided into five sets to the prediction angle), a different filter is trained. Furthermore, for example, two distinct sets of networks for the DCT-II and DST-VII are optimized. It is to be noted, for instance, that MIP may use three sets of prediction matrices: one for 4×4 blocks, one for blocks of shape 8×8, 4×H and W×4 and one for the remaining shapes. Hence, for example, filters for the MIP modes are trained for 4×4, 8×8 and 16×16 only. For example, for the remaining shapes, one of these filters is selected according to the MIP design. For instance, the coefficient filter can be disallowed for blocks using the MRL or ISP tool, when the ISP sub-partition shape is not supported by the described filters. For instance, in the case of LFNST, the DCT-II filters are applied after the inverse LFNST and before the primary inverse transform. For example, the coefficient filter may be applied when a block uses a valid combination of intra mode and transform. For example, the encoder, such as the encoder 100, regards the correct distortion MSE (x, \hat{x}) by examining each complete path of reconstructed transform coefficients within TCQ as

$$M S E ( x , \hat{x} ) = {\sum }_{n = 0}^{W H - 1} {( {t}_{n} - ( {\hat{t}}_{n} + {f}_{n} ) )}^{2}$$

Hence, for example, at the decoder such as the decoder 10, the filter 37 is applied after all the transform coefficients have been reconstructed possibly using the coefficient prediction network 31.

### V. Experimental Results

For instance, experiments are conducted using video sequences and All-Intra (AI) coding configuration according to JVET common test condition (CTC) [27]. For example, classes A1 and A2 account for UHD, classes B and E for HD, and classes C and D for SD content. For example, luma-only coding is tested and BD-rate savings are measured over two overlapping sets of QP values {22, 27, 32, 37} and {27, 32, 37, 42} which account for different bitrate ranges.

### V. I. Performance of the Nonlinear Coefficient Prediction

Table III presents an example of the results of using the network associated with the nonlinear coefficient prediction 31 only. Although, for example, the tool is allowed for the combination of the PLANAR mode with the DCT-II or DST-VII, the bitrate savings are consistent around 0.4% over high resolution classes and both bitrate ranges. For instance, the coding gain apparently increases for higher resolution sequences, possibly due to the angular modes being selected less often. For instance, in high resolution sequences, a larger portion of blocks has no preferred prediction direction and thus, is coded using the PLANAR, DC or a MIP mode.

TABLE III
THE LUMA (Y) BD-RATES OF THE COEFFICIENT PREDICTION
NETWORK AGAINST VTM-14.2 IN AI CONFIGURATION.
QP values = 22, 27, 32, 37

| A1 | A2 | B | C | D | E | Total |
|---|---|---|---|---|---|---|
| −0.40% | −0.39% | −0.40% | −0.21% | −0.22% | −0.43% | −0.36% |

QP values = 27, 32, 37, 42

| A1 | A2 | B | C | D | E | Total |
|---|---|---|---|---|---|---|
| −0.40% | −0.42% | −0.40% | −0.20% | −0.22% | −0.35% | −0.35% |

### V.II. Performance of the Nonlinear Coefficient Filtering

Table IV presents an example of the results of using the network associated with the nonlinear coefficient filtering 37. For instance, in comparison to the coefficient prediction 31, the bitrate savings are roughly three to four times larger at the cost of increased computational complexity. First, for example, the filters 37 are available for almost all possible intra modes in contrast to the coefficient prediction 31. Furthermore, for example, the filters 37 are about five times more complex than the coefficient prediction 31 in terms of multiplications per sample. For example, with regard to the observed bitrate savings, the coding gain is higher for low bitrates which seems surprising because QP 42, i.e. QP having a value 42, is not used for generating the database. However, for example, a possible reason for this behavior could be that there are larger quantization errors to be corrected by the filter 37 for higher QP values. For instance, the observation could also hint towards including other QP values for generating the training data.

TABLE IV
THE LUMA (Y) BD-RATES OF THE COEFFICIENT FILTER
NETWORK AGAINST VTM-14.2 IN AI CONFIGURATION.
QP values = 22, 27, 32, 37

| A1 | A2 | B | C | D | E | Total |
|---|---|---|---|---|---|---|
| −1.34% | −0.98% | −0.95% | −0.77% | −0.74% | −1.40% | −1.05% |

QP values = 27, 32, 37, 42

| A1 | A2 | B | C | D | E | Total |
|---|---|---|---|---|---|---|
| −1.76% | −1.64% | −1.39% | −1.02% | −0.97% | −1.62% | −1.45% |

### V.III Performance of the Entire Network

Table V presents an example of the results of using the entire network, performing the nonlinear filter 37 after all transform coefficients of the block 12 have been reconstructed by using the network associated with the prediction 31. It is to noted, for instance, that the bitrate savings of the combined tool against VTM-14.2 is larger than the sum of savings for each component separately; compare Tables III and IV. For example, the described experiments suggest that it is crucial to accurately consider the joint impact of both networks in the encoder 100 decisions. For instance, it is reported that overall luma bitrate savings of −1.57/−1.99% are in accordance with the results presented in the last column of Table V.

TABLE V
THE LUMA (Y) BD-RATES OF THE COEFFICIENT FILTER
NETWORK AGAINST VTM-14.2 IN AI CONFIGURATION.
QP values = 22, 27, 32, 37

| A1 | A2 | B | C | D | E | Total |
|---|---|---|---|---|---|---|
| −1.99% | −1.55% | −1.49% | −1.04% | −1.04% | −1.98% | −1.57% |

QP values = 27, 32, 37, 42

| A1 | A2 | B | C | D | E | Total |
|---|---|---|---|---|---|---|
| −2.47% | −2.31% | −1.96% | −1.28% | −1.26% | −2.16% | −1.99% |

Conclusively, this application presents a novel concept for designing nonlinear coding tools for the transform coding of intra prediction residuals such as VVC intra prediction residuals. This approach relates to two components. At the decoder 10 side, a nonlinear network 29 may predict 31 transform coefficients from previously reconstructed ones and the block boundary 13. After the final coefficient of the block 12 is reconstructed, another network may filter 37 these coefficients before the inverse transform is applied. This network may use the intra prediction signal, the QP value and the intra mode index as additional inputs. The networks, for instance, may be designed in a way that the encoder 100 is able to compute their joint impact on the rate-distortion correctly. Using a VVC reference software implementation, luma bitrate savings across all classes ranging from 1.04% to 2.47% in terms of Bjøntegaard-Delta bitrate (BD-rate) are reported.

In the following, further implementation alternatives are described, referring to all of the embodiments described above.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In particular, it is noted that FIG. 4 may also be regarded as illustration of a method for decoding a video and FIG. 5 may be regarded as illustration of a method for encoding a video, where the blocks, modules and stages may be regarded as steps of methods.

Some or all of the method steps may be executed by (or using) a hardware apparatus, like for example, a microprocessor, a programmable computer or an electronic circuit. In some embodiments, one or more of the most important method steps may be executed by such an apparatus.

The inventive encoded image signal can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] B. Bross, J. Chen, J. R. Ohm, G. J. Sullivan, and Y. K. Wang, “Developments in International Video Coding Standardization After AVC, With an Overview of Versatile Video Coding (VVC),” Proceedings of the IEEE, pp. 1-31, 2021.
[2] “Versatile Video Coding,” ITU-T Rec. H.266 and ISO/IEC 23090-3, 2020.
[3] W. Han G. J. Sullivan, J.-R. Ohm and T. Wiegand, “Overview of the high efficiency video coding (HEVC) standard,” IEEE Transactions on Circuits and Systems for Video Technology, vol. 22, no. 12, pp. 1649-1668, 2012.
[4] “High Efficiency Video Coding,” ITU-T Rec. H.265 and ISO/IEC 23008-10, 2013.
[5] Ankur Saxena and Felix C. Fernandes, “DCT/DST-Based Transform Coding for Intra Prediction in Image/Video Coding,” IEEE Transactions on Image Processing, vol. 22, no. 10, pp. 3974-3981, 2013.
[6] N. Ahmed, T. Natarajan, and K. R. Rao, “Discrete Cosine Transform,” IEEE Transactions on Computers, vol. C-23, no. 1, pp. 90-93, 1974.
[7] Moonmo Koo, Mehdi Salehifar, Jaehyun Lim, and Seung-Hwan Kim, “Low Frequency Non-Separable Transform (LFNST),” in 2019 Picture Coding Symposium (PCS), 2019, pp. 1-5.
[8] Xin Zhao, Seung-Hwan Kim, Yin Zhao, Hilmi E. Egilmez, Moonmo Koo, Shan Liu, Jani Lainema, and Marta Karczewicz, “Transform Coding in the VVC Standard,” IEEE Transactions on Circuits and Systems for Video Technology, vol. 31, no. 10, pp. 3878-3890, 2021.
[9] Heiko Schwarz, Tung Nguyen, Detlev Marpe, and Thomas Wiegand, “Hybrid Video Coding with Trellis-Coded Quantization,” in 2019 Data Compression Conference (DCC), 2019, pp. 182-191.
[10] Heiko Schwarz, Muhammed Coban, Marta Karczewicz, Tzu-Der Chuang, Frank Bossen, Alexander Alshin, Jani Lainema, Christian R. Helmrich, and Thomas Wiegand, “Quantization and Entropy Coding in the Versatile Video Coding (VVC) Standard,” IEEE Transactions on Circuits and Systems for Video Technology, vol. 31, no. 10, pp. 3891-3906, 2021.
[11] G. J. Sullivan, “Efficient scalar quantization of exponential and Laplacian random variables,” IEEE Transactions on Information Theory, vol. 42, no. 5, pp. 1365-1374, 1996.
[12] Matthias Narroschke, “Coding Efficiency of the DCT and DST in Hybrid Video Coding,” IEEE Journal of Selected Topics in Signal Processing, vol. 7, no. 6, pp. 1062-1071, 2013.
[13] V. K. Goyal, “Theoretical foundations of transform coding,” IEEE Signal Processing Magazine, vol. 18, no. 5, pp. 9-21, 2001.
[14] Johannes Balle', Philip A. Chou, David Minnen, Saurabh Singh, Nick Johnston, Eirikur Agustsson, Sung Jin Hwang, and George Toderici, “Nonlinear Transform Coding,” IEEE Journal of Selected Topics in Signal Processing, vol. 15, no. 2, pp. 339-353, 2021.
[15] Johannes Balle', David Minnen, Saurabh Singh, Sung Jin Hwang, and Nick Johnston, “Variational image compression with a scale hyperprior,” in International Conference on Learning Representations, 2018.
[16] David Minnen, Johannes Balle', and George D Toderici, “Joint au-toregressive and hierarchical priors for learned image compression,” Advances in neural information processing systems, vol. 31, 2018.
[17] David Minnen and Saurabh Singh, “Channel-Wise Autoregressive Entropy Models for Learned Image Compression,” in 2020 IEEE International Conference on Image Processing (ICIP), 2020, pp. 3339-3343.
[18] Yueyu Hu, Wenhan Yang, and Jiaying Liu, “Coarse-to-Fine Hyper-Prior Modeling for Learned Image Compression,” in AAAI Conference on Artificial Intelligenc, 2020.
[19] Jun-Hyuk Kim, Byeongho Heo, and Jong-Seok Lee, “Joint Global and Local Hierarchical Priors for Learned Image Compression,” in 2022 IEEE/CVF Conference on Computer Vision and Pattern Recognition (CVPR), 2022, pp. 5982-5991.
[20] Michael Schäfer, Sophie Pientka, Jonathan Pfaff, Heiko Schwarz, Detlev Marpe, and Thomas Wiegand, “Rate-Distortion Optimized Encoding for Deep Image Compression,” IEEE Open Journal of Circuits and Systems, vol. 2, pp. 633-647, 2021.
[21] Fabian Brand, Kristian Fischer, Alexander Kopte, Marc Windsheimer, and Andre' Kaup, “RDONet: Rate-Distortion Optimized Learned Image Compression With Variable Depth,” in Proceedings of the IEEE/CVF Conference on Computer Vision and Pattern Recognition (CVPR) Work-shops, June 2022, pp. 1759-1763.
[22] A. Browne, J. Chen, Y. Ye, and S. Kim, “Algorithm description for Versatile Video Coding and Test Model 14 (VTM 14),” JVET-W2002, Joint Video Experts Team (JVET), September 2021.
[23] G. Bjontegaard, “Calculation of average PSNR differences between RD-Curves,” Proceedings of the ITU-T Video Coding Experts Group (VCEG) Thirteenth Meeting, January 2001.
[24] Changyue Ma, Dong Liu, Xiulian Peng, Li Li, and Feng Wu, “Con-volutional Neural Network-Based Arithmetic Coding for HEVC Intra-Predicted Residues,” IEEE Transactions on Circuits and Systems for Video Technology, vol. 30, no. 7, pp. 1901-1916, 2020.
[25] Di Ma, Fan Zhang, and David R. Bull, “BVI-DVC: A Training Database for Deep Video Compression,” IEEE Transactions on Multimedia, vol. 24, pp. 3847-3858, 2022.
[26] Joint Video Experts Team (JVET), “VVC VTM reference soft-ware,” https://vcgit.hhi.fraunhofer.de/jvet/VVCSoftware VTM, Novem-ber 2023.
[27] F. Bossen, X. Li, K. Sharman, V. Seregin, and K. Suehring, “VTM and HM common test conditions and software reference configurations for SDR 4:2:0 10-bit video,” JVET-AB2010, Joint Video Experts Team (JVET), January 2022.
[28] Diederik P. Kingma and Jimmy Ba, “Adam: A method for stochastic optimization,” 2017.

1. A block based decoder for decoding a predetermined block of a picture, configured to
predict a predicted sample filling of the predetermined block,
decode a transform of a prediction residual for the predetermined block from a data stream,
improve the transform by
computing an additive offset mask for the transform using an improvement function attributes of which comprise
the transform, and
the predicted sample filling, and
subject the transform to a reverse transformation, and
correct the predicted sample filling using the prediction residual.

2. The block based decoder of claim 1, configured to
predict the predicted sample filling of the predetermined block, by
selecting a selected intra-prediction mode out of a plurality of intra-prediction modes, and
predicting the predicted sample filling using the selected intra-prediction mode,
wherein the attributes of the improvement function additionally comprise
an index of the selected intra-prediction mode.

3. The block based decoder of claim 1, wherein the improvement function is non-linear with respect to
the transform,
the predicted sample filling, and
the index of the selected intra-prediction mode.

4. The block based decoder of claim 1, wherein the attributes of the improvement function further comprise a quantization parameter of the predetermined block.

5. The block based decoder of claim 1, wherein the plurality of intra-prediction modes comprise one or more of
a DC mode,
a planar mode,
a plurality of angular modes,
one or more matrix-based intra prediction modes, according to each of which the predicted sample filling is acquired by a multiplication between a matrix associated with the respective matrix-based intra prediction mode and a vector acquired from sample values in a neighborhood of the predetermined block, and
one or more intra-subpartition modes, according to each of which the predicted sample filling is acquired by subdividing the predetermined block into subpartitions and intra-predicting the subpartitions sequentially with correcting a subpartition using the prediction residual before intra-predicting a next subpartition.

6. The block based decoder of claim 1, wherein the improvement function is implemented by
for each of the plurality of intra-prediction modes or for each group of intra-prediction modes into which the plurality of intra-prediction modes are grouped,
a neural network, comprising an initial non-linear fully-connected layer and one or more succeeding layers, the neural network configured to
receive the transform, the predicted sample filling and the index of the selected intra-prediction mode as inputs of the initial layer,
receive an output of the initial layer as an input of the one or more succeeding layers,
perform an inference based on the transform and the predicted sample filling, and wherein the block based decoder is configured to compute the additive offset mask by use of the neural network, which is for the selected intra-prediction mode or for the group which the selected intra-prediction modes is part of.

7. The block based decoder of claim 6, wherein a final layer of the one or more succeeding layers is a linear layer.

8. The block based decoder of claim 1, wherein the improvement function is implemented by a neural network, and the block based decoder is configured to
support one or more of a number of different block sizes for the predetermined block, and
compute the additive offset mask by selecting and using a neural network, which is associated with a size of the predetermined block.

9. The block based decoder of claim 1, wherein the improvement function is implemented by a neural network, and the block based decoder is configured to
support one or more of a number of different transform types for the predetermined block, and
compute the additive offset mask by selecting and using a neural network, which is associated with a transform type of the predetermined block.

10. The block based decoder of claim 1, wherein the improvement function is implemented by a neural network, and the block based decoder is configured to
support one or more of a number of different block sizes for the predetermined block, and
compute the additive offset mask by selecting and using a neural network, which is associated with a size of the predetermined block, wherein, for if the size exceeds a predetermined size limit, the neural network takes, as an input, merely a sub-portion of the transform.

11. The block based decoder of claim 1, configured to decode the index of the selected intra-prediction mode from the data stream.

12. The block based decoder of claim 1, wherein the transform is a DCT or DST.

13. The block based decoder of claim 1, configured to decode the transform of the prediction residual from the data stream using entropy decoding.

14. A method for block based decoding a predetermined block of a picture,
wherein the method comprises predicting a predicted sample filling of the predetermined block,
wherein the method comprises decoding a transform of a prediction residual for the predetermined block from a data stream,
wherein the method comprises improving the transform by
computing an additive offset mask for the transform using an improvement function attributes of which comprise
the transform, and
the predicted sample filling, and
wherein the method comprises subjecting the transform to a reverse transformation, and
wherein the method comprises correcting the predicted sample filling using the prediction residual.

15. A method for block based encoding a predetermined block of a picture,
wherein the method comprises predicting a predicted sample filling of the predetermined block,
wherein the method comprises encoding a transform of a prediction residual for the predetermined block into a data stream, as part of a R/D optimizer and/or a prediction loop of the block based encoder,
wherein the method comprises improving the transform by
computing an additive offset mask for the transform using an improvement function attributes of which comprise
the transform, and
the predicted sample filling, and
wherein the method comprises subjecting the transform to a reverse transformation, and
wherein the method comprises correcting the predicted sample filling using the prediction residual.

16. A non-transitory digital storage medium having stored thereon a computer program for performing a method for block based decoding a predetermined block of a picture,
wherein the method comprises predicting a predicted sample filling of the predetermined block,
wherein the method comprises decoding a transform of a prediction residual for the predetermined block from a data stream,
wherein the method comprises improving the transform by
computing an additive offset mask for the transform using an improvement function attributes of which comprise
the transform, and
the predicted sample filling, and
wherein the method comprises subjecting the transform to a reverse transformation, and
wherein the method comprises correcting the predicted sample filling using the prediction residual,
when the computer program is run by a computer.

17. A non-transitory digital storage medium having stored thereon a computer program for performing a method for block based encoding a predetermined block of a picture,
wherein the method comprises predicting a predicted sample filling of the predetermined block,
wherein the method comprises encoding a transform of a prediction residual for the predetermined block into a data stream, as part of a R/D optimizer and/or a prediction loop of the block based encoder,
wherein the method comprises improving the transform by
computing an additive offset mask for the transform using an improvement function attributes of which comprise
the transform, and
the predicted sample filling, and
wherein the method comprises subjecting the transform to a reverse transformation, and
wherein the method comprises correcting the predicted sample filling using the prediction residual,
when the computer program is run by a computer.

18. A data stream comprising an encoded representation of a predetermined block of a picture, encoded using the method according to claim 15.
